(19) United States
(12) Patent Application Publication
(10) Pub. No.: US 2021/0279961 A1
(43) Pub. Date: Sep. 9, 2021

(54) INFORMATION PROVIDING DEVICE, TERMINAL DEVICE, DISPLAY SYSTEM, STORAGE MEDIUM, AND INFORMATION PROVIDING METHOD

(71) Applicant: SHARP KABUSHIKI KAISHA

(72) Inventor: AKIRA WATANABE, Sakai City, Osaka (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/486,060

(22) PCT Filed: Dec. 1, 2017
(86) PCT No.: PCT/JP2017/043354

§ 371 Date: Aug. 14, 2019

(30) Foreign Application Priority Data
Mar. 31, 2017 (JP) 2017-071774

(51) Int. Cl. G06T 19/00; G06K 9/00; G06K 9/62; G06F 3/16

(52) U.S. Cl. CPC G06T 19/006; G06F 3/16; G06K 9/6267; G06K 9/00664

(57) ABSTRACT

The server control section of the server carries out control of at least either referring to device identification information and determining character management information, and transmitting the determined character management information to the terminal device, or referring to character management information and determining device management information, and transmitting the determined device management information to the household electric appliance.

### TECHNICAL FIELD

The present invention relates to an information providing device, a terminal device, a display system, a program, and an information providing method.

### BACKGROUND ART

There has been known as a conventional technique an augmented reality technique of superimposing a character image at a position over an image captured with use of a terminal device or the like which position is in the vicinity of a marker in the captured image.

Patent Literature 1, for example, discloses an information processing device configured to, in a case where the information processing device has detected a marker in a captured image, (i) start processing information in correspondence with the marker, (ii) position an object of a corresponding character or icon in a three dimensional coordinate system corresponding to the subject space, and (iii) render the object over the captured image for instant display.

### CITATION LIST

### Patent Literature

### Patent Literature 1

Japanese Patent Application Publication, Tokukai, No. 2015-41126 (Publication date: Mar. 2, 2015)

### SUMMARY OF INVENTION

### Technical Problem

Conventional techniques such as the above merely refer to information of a marker on a device or the like and superimpose a character image over a captured image. The device and the character are thus poorly related to each other, with the unfortunate result that the user does not easily feel an affinity for the character.

The present invention has been accomplished in view of the above issue. It is an object of the present invention to improve the relation between a device and a character over conventional techniques.

### Solution to Problem

In order to attain the above object, an information providing device according to an aspect of the present invention is an information providing device for providing information to a terminal device configured to superimpose an image of a character over a captured image, the information providing device including: a communication section; and a control section, the control section being configured to carry out control of at least either (i) referring to device identification information for identifying an individual device shown in the captured image and (ii) determining character management information for managing a form of presenting the character, and transmitting the determined character management information to the terminal device via the communication section, or referring to the character management information and determining device management information for determining a state that the individual device presents, and transmitting the determined device identification information to the individual device via the communication section.

In order to attain the above object, a terminal device according to an aspect of the present invention is a terminal device including: an image capturing section; a presenting section; a control section; and a communication section, the presenting section including a display section, the control section being configured to carry out control of at least either (i) obtaining, from an information providing device for providing information to the terminal device, character management information for managing a form of presenting a character which character management information has been determined with reference to device identification information for identifying an individual device shown in a captured image and (ii) causing the display section to superimpose an image of the character over the captured image captured by the image capturing section, or transmitting the device identification information for identifying the individual device to the information providing device via the communication section.

In order to attain the above object, a display system according to an aspect of the present invention is a display system including: an information providing device; and a terminal device, the terminal device including: an image capturing section; a presenting section; a terminal control section; and a terminal communication section, the presenting section including a display section, the information providing device including: a server communication section; and a server control section, the server control section being configured to carry out control of at least either (i) referring to device identification information for identifying an individual device shown in a captured image and (ii) determining character management information for managing a form of presenting a character, and transmitting the determined character management information to the terminal device via the server communication section, or referring to the character management information and determining device management information for determining a state that the individual device presents, and transmitting the determined device identification information to the individual device via the server communication section, the terminal control section being configured to refer to the character management information and cause the display section to superimpose an image of the character over the captured image captured by the image capturing section.

In order to attain the above object, an information providing method according to an aspect of the present invention is an information providing method for providing information to a terminal device configured to superimpose an image of a character over a captured image, the information providing method including at least either: (i) referring to device identification information for identifying an individual device shown in the captured image and (ii) determining character management information for managing a form of presenting the character, and transmitting the determined character management information to the terminal device, or referring to the character management information and determining device management information for determining a state that the individual device presents, and transmitting the determined device identification information to the individual device.

### Advantageous Effects of Invention

An aspect of the present invention advantageously allows the relation between a device and a character to be improved over conventional art.

### BRIEF DESCRIPTION OF DRAWINGS

FIG. 1 is a block diagram illustrating the configuration of a main part of the display system according to Embodiment 1 of the present invention.

FIG. 2 is a diagram schematically illustrating a display system according to Embodiment 1 of the present invention.

FIG. 3 provides diagrams illustrating examples of a character management DB, a character storage DB, and a device management DB each stored in a storage section of a server according to Embodiment 1 of the present invention.

FIG. 4 is a sequence diagram illustrating an example flow of an information providing process carried out by a display system according to Embodiment 1 of the present invention.

FIG. 5 is a sequence diagram illustrating an example flow of an information providing process carried out by a display system according to Embodiment 1 of the present invention.

FIG. 6 is a sequence diagram illustrating an example flow of an information providing process carried out by a display system according to Embodiment 1 of the present invention.

FIG. 7 is a sequence diagram illustrating an example flow of an information providing process carried out by a display system according to Embodiment 1 of the present invention.

FIG. 8 is a sequence diagram illustrating an example flow of an information providing process carried out by a display system according to Embodiment 2 of the present invention.

FIG. 9 is a sequence diagram illustrating an example flow of an information providing process carried out by a display system according to Embodiment 3 of the present invention.

FIG. 10 is a sequence diagram illustrating an example flow of an information providing process carried out by a display system according to Embodiment 3 of the present invention.

FIG. 11 is a sequence diagram illustrating an example flow of an information providing process carried out by a display system according to Embodiment 3 of the present invention.

FIG. 12 is a sequence diagram illustrating an example flow of an information providing process carried out by a display system according to Embodiment 4 of the present invention.

FIG. 13 is a block diagram illustrating the configuration of a main part of the display system according to Embodiment 5 of the present invention.

FIG. 14 is a block diagram illustrating an example configuration of a computer usable as a server or a terminal device.

### DESCRIPTION OF EMBODIMENTS

### Embodiment 1

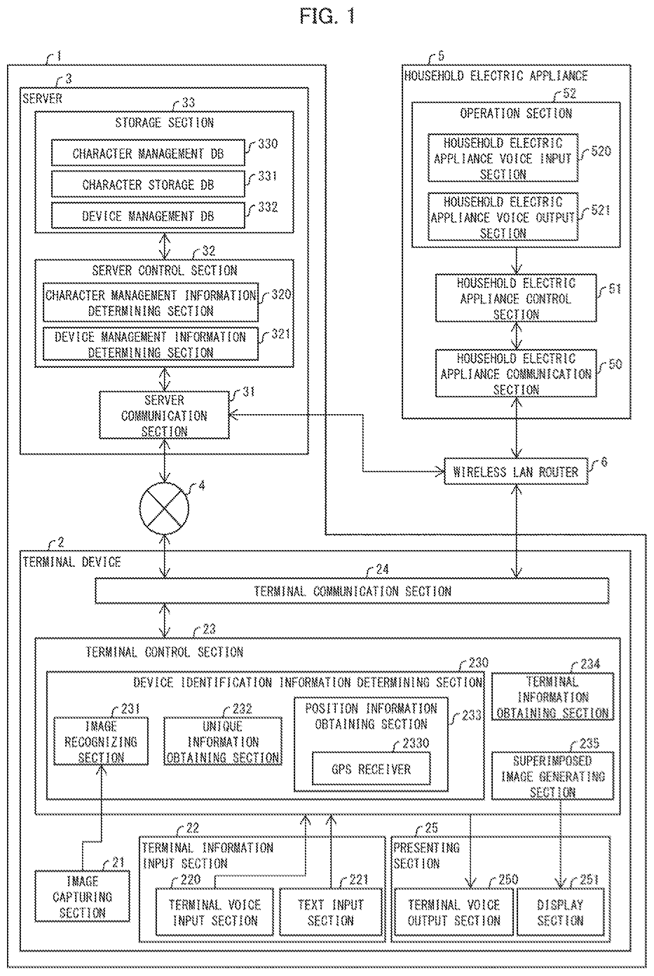

The following description will discuss a display system 1 according to the present embodiment with reference to FIGS. 1 to 7. The arrangements described for the present embodiment are not intended to limit the scope of the present invention to such arrangements, and are a mere illustrative example unless otherwise specified particularly.

[Display System 1]

The description below deals with the configuration of a main part of the display system 1 according to the present embodiment with reference to FIG. 1.

FIG. 1 is a block diagram of the configuration of a main part of the display system 1 according to the present embodiment. The display system 1, as illustrated in FIG. 1, includes a terminal device 2 and a server (information providing device) 3. The terminal device 2 and the server 3 are connected to each other over a network 4. The terminal device 2 is connected to a household electric appliance 5 via a wireless LAN router 6.

[Terminal Device 2]

The description below deals with the configuration of the terminal device 2 according to the present embodiment with reference to FIG. 1. As illustrated in FIG. 1, the terminal device 2 according to the present embodiment includes an image capturing section 21, a terminal information input section 22, a terminal control section (control section) 23, a terminal communication section (communication section) 24, and a presenting section 25.

Examples of the terminal device 2 include a smartphone and a head-mounted display.

The image capturing section 21 and the presenting section 25 may each he a single piece of hardware or include a plurality of functionally separate pieces of hardware.

[Image Capturing Section 21]

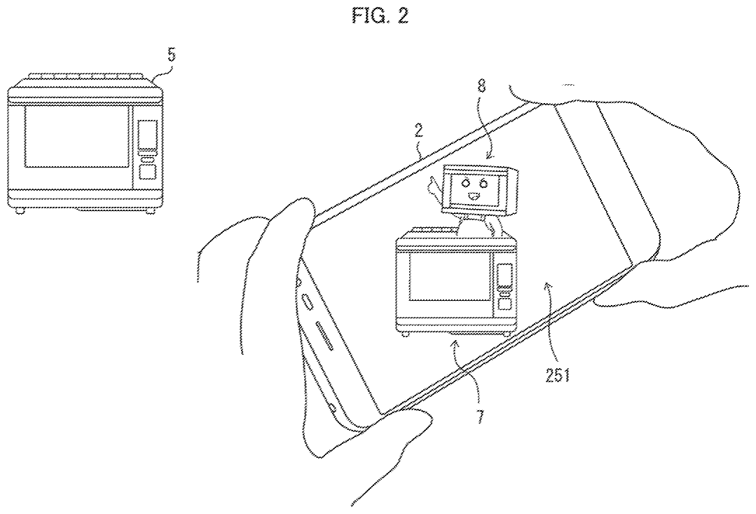

The image capturing section 21 is used to capture an image 7 (see FIG. 2) of a household electric appliance (device) 5. Examples of the image capturing section 21 include a camera.

[Terminal Information Input Section 22]

The terminal information input section 22 receives from the user an input such as (i) terminal identification information such as an app ID and a password, (ii) character management information such as a character ID, an information ID, and character related information, and (iii) speech information. As illustrated in FIG. 1, the terminal information input section 22 includes a terminal voice input section 220 and a text input section 221.

[Terminal Voice Input Section 220]

The terminal voice input section 220 is used to input the above various pieces of information through voice input. Examples of the terminal voice input section 220 include a microphone.

[Text Input Section 221]

The text input section 221 is used to input the above various pieces of information through text input. Examples of the text input section 221 include a keyboard, a button, and a touch panel that allows the user to input text with use of a finger of the user's or a stylus. In the case of a touch panel, a display section 251 as illustrated in FIG. 2 may, for instance, double as such a touch panel.

The terminal information input section 22 may be configured to, in place of or in addition to using the terminal voice input section 220 and/or the text input section 221, prompt the user to select one of a plurality of options to receive an input of terminal identification information. The terminal information input section 22 may be configured to, for instance, prompt the user to touch a button as an option on the display section 251 such as a touch panel to receive an input of terminal identification information. This configuration allows the terminal information input section 22 to receive terminal identification information from the user more rapidly.

[Terminal Control Section 23]

The terminal control section 23 transmits device identification information to the server 3 via the terminal communication section 24. The terminal control section 23 also obtains character management information via the terminal communication section 24. The terminal control section 23 then refers to the character management information and causes the display section 251 to superimpose an image of a character 8 over an image 7 captured by the image capturing section 21.

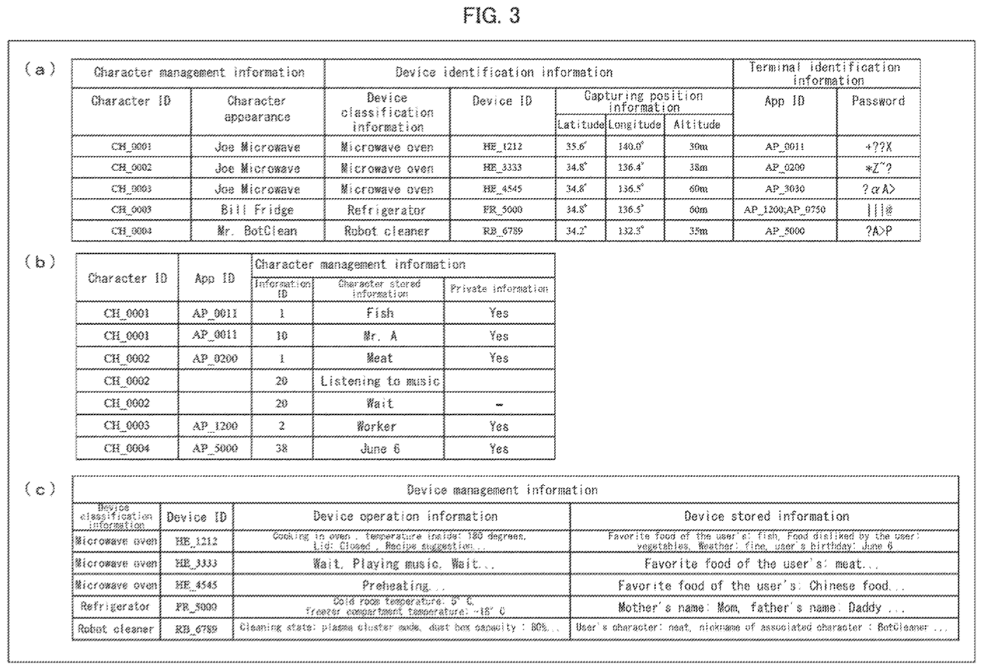

Device identification information refers to information for identification of an individual household electric appliance 5 shown in an image 7 captured by the image capturing section 21. Specifically, device identification information is, for example, information including a device ID or a combination of capturing position information and device classification information in a character management DB (database) 330 in FIG. 3.

Device classification information is information on the classification of a household electric appliance 5 which information is obtained from the appearance of the household electric appliance 5.

A device ID is an ID that uniquely identifies a household electric appliance 5. Each household electric appliance 5 is assigned an ID. A device ID is, in other words, information that is obtained through communication with a household electric appliance 5 shown in a captured image 7 and that is unique to the household electric appliance 5.

As described later, determining the device ID of a household electric appliance 5 shown in a captured image 7 requires being capable of identifying device classification information associated with each device ID. Device classification information associated with each device ID may be determined by, for example, (i) the character management DB (database) 330 providing such association, (ii) a household electric appliance 5 presenting its device ID and device classification information as a set of information, or (iii) a device ID being arranged to include device classification information.

Capturing position information is information on the position of the capturing of an image 7 that shows a household electric appliance 5. Such a position is indicated with, for example, a latitude, a longitude, and an altitude. The present embodiment assumes that in a building such as a typical house, even in a case where an image captured at a position shows a plurality of household electric appliances 5, no two among those household electric appliances 5 will share identical device identification information. On this assumption, each household electric appliance 5 should be uniquely identified on the basis of information including capturing position information for a captured image 7 and device identification information for a household electric appliance 5 shown in the captured image 7.

Character management information is used to manage the form of presenting a character 8 associated with each household electric appliance 5. Specifically, character management information refers to information including, for example, a character ID and information on the appearance as shown in the character management DB 330 in (a) of FIG. 3. Character management information further includes an information ID and character related information as shown in the character storage DB 331 in (b) of FIG. 3. Character management information may further include speech content and information on the clothes and facial expression of a character 8 (not shown in FIG. 3).

A character ID is an ID assigned to a character 8. The appearance of a character 8 is, for example, that of a character (Joe Microwave) of, in a case where the household electric appliance 5 is a microwave oven as illustrated in FIG. 2, a microwave oven personified with a face and deformed. An information ID indicates the type of information stored on the character 8. Character related information refers to details of information on the character 8 for the information ID. Character related information includes, for example, (i) information obtained from a history of conversation between the character 8 and the user and (ii) information on the character 8 itself. The content of speech by the character 8 refers to the content of speech by the character 8. Example speech methods include (i) presenting a speech with text and (ii) vocal speech. The clothes of the character 8 refer to the clothes that the character 8 wears.

In the above example, device identification information includes, for example, device classification information, a device ID, and capturing position information. Character management information includes, for example, a character ID, information on the appearance of a character 8, an information ID, character related information, the content of speech by the character 8, and the clothes of the character 8. The present embodiment is, however, not limited to such an arrangement.

For the present embodiment, device identification information may be any information as long as it is information for identification of an individual household electric appliance 5 shown in an image 7 captured by the image capturing section 21. Further, character management information may be any information as long as it is used to manage the form of presenting a character 8 associated with each household electric appliance 5.

The above example involves capturing an image 7 of a household electric appliance 5. The present embodiment is, however, not limited to such an arrangement. For the present embodiment, image capturing is riot limited to capturing an image of a household electric appliance. An image 7 may be captured of, for example, an electric appliance other than a household electric appliance.

The description below deals with the configuration of the terminal control section 23 with reference to FIG. 1. As illustrated in FIG. 1, the terminal control section 23 includes a device identification information determining section 230, a terminal information obtaining section 234, and a superimposed image generating section 235.

[Device Identification Information Determining Section 230]

The device identification information determining section 230 determines device identification information.

As illustrated in FIG. 1, the device identification information determining section 230 functions as an image recognizing section 231, a unique information obtaining section 232, and a position information obtaining section 233.

The image recognizing section 231 determines device classification information. The unique information obtaining section 232 determines a device ID. The position information obtaining section 233 determines capturing position information. This configuration allows the device identification information determining section 230 to refer to a device ID or a combination of capturing position information and device classification information to determine device identification information.

(Image Recognizing Section 231)

The image recognizing section 231 refers to an image 7 captured by the image capturing section 21 and determines device classification information for a household electric appliance 5. It is assumed, for instance, that the image capturing section 21 of the terminal device 2 such as a smartphone has captured an image of a household electric appliance 5. The image recognizing section 231, in this case, uses a publicly known image recognition technique to determine that the household electric appliance 5 shown in the image 7 captured by the image capturing section 21 is, for example, a microwave oven. The device classification information thus indicates a microwave oven.

In the above example, the terminal control section 23 of the terminal device 2 functions as the image recognizing section 231. The present embodiment is, however, not limited to such an arrangement. The present embodiment may be arranged, for instance, such that device classification information is determined by a server control section 32 of the server 3. In other words, the server control section 32 may function as the image recognizing section 231.

In the above case, the server control section 32 receives a captured image 7 from the terminal device 2 and determines device classification information. The server control section 32 may also (i) refer to the device classification information and at least one of a device ID, capturing position information, and the like received from the terminal device 2 and (ii) determine device identification information. In other words, the present embodiment may be arranged such that in place of the terminal control section 23, the server control section 32 functions as the device identification information determining section 230.

(Unique Information Obtaining Section 232)

The unique information obtaining section 232 obtains unique information such as a device ID, as the terminal communication section 24 communicates with a household electric appliance communication section 50 of a household electric appliance 5.

As illustrated in FIG. 1, the terminal communication section 24 and the household electric appliance communication section 50 each establish a Wi-Fi (registered trademark) connection with an identical wireless LAN communication device such as the wireless LAN router 6 to communicate with each other via the wireless LAN communication device. This allows the unique information obtaining section 232 to obtain a device ID and wireless LAN router identification information.

The terminal communication section 24 and the household electric appliance communication section 50 may be configured to communicate directly with each other with use of, for example, Bluetooth (registered trademark) instead of communicating with each other via the wireless LAN router 6. The unique information obtaining section 232 may be configured to obtain information for identification of a device ID as such.

The description below deals with an example of specifically how the unique information obtaining section 232 obtains a device ID.

(Specifically How the Unique Information Obtaining Section 232 Obtains a device ID: Example 1)

The unique information obtaining section 232 instructs, via the terminal communication section 24, each household electric appliance 5 connected to the wireless LAN router 6 to transmit its device ID to the unique information obtaining section 232. The unique information obtaining section 232 thereby obtains a plurality of device IDs from a plurality of household electric appliances 5. The unique information obtaining section 232 determines, from among the plurality of device IDs, the device ID of a household electric appliance 5 shown in a captured image 7.

In a building such as a typical house, no two household electric appliances 5 connected to an identical wireless LAN router 6 share identical device classification information. In view of that, the unique information obtaining section 222 of the present embodiment (i) assumes that each device ID obtainable through an identical wireless LAN router 6 is associated with a single piece of device classification information, and (ii) on this assumption, determines a device ID on the basis of device classification information for a household electric appliance 5 shown in a captured image 7 which device classification information has been determined. by the image recognizing section 231.

The unique information obtaining section 232 may, for instance, refer to the character management DB 330 and determine the device ID associated with device classification information for a household electric appliance 5 shown in a captured image 7.

In a case where a device ID includes device classification information, the unique information obtaining section 232 may obtain device classification information together with the device ID from each household electric appliance 5 and use the device classification information and the device ID to determine the device ID of a household electric appliance 5 shown in a captured image 7.

(Specifically How the Unique Information Obtaining Section 232 Obtains a Device ID: Example 2)

The unique information obtaining section 232 may alternatively be configured to (i) transmit, to each household electric appliance 5 connected to the wireless LAN router 6, device classification information for a household electric appliance 5 shown in a captured image 7 which device classification information has been determined by the image recognizing section 231 and (ii) in a case where the device classification information transmitted matches the device classification information for the household electric appliance 5 itself, instruct the household electric appliance 5 to transmit its device ID to the unique information obtaining section 232. Similarly to example 1 above, the unique information obtaining section 232 assumes that no two household electric appliances 5 connected to an identical wireless LAN router 6 share identical device identification information, and on this assumption, determines the device ID of a household electric appliance 5 shown in the captured image 7.

(Position Information Obtaining Section 233)

The position information obtaining section 233 obtains capturing position information. As illustrated in FIG. 1, the position information obtaining section 233 includes a GPS receiver 2330. The position information obtaining section 233 uses the GPS receiver 2330 to obtain, as capturing position information, information on the current position of the terminal device 2 when the terminal device 2 captured an image 7.

In a building such as a typical house, among all household electric appliances 5 an image of which can be captured at an identical capturing position, no two household electric appliances 5 share identical device identification information. In view of that, the present embodiment assumes that if a household electric appliance 5 is shown in captured images 7 having identical capturing position information and is associated with device classification information, that household electric appliance 5 is uniquely identified. On this assumption, the server control section 32 refers to (i) capturing position information obtained by the position information obtaining section 233 and associated with a captured image 7 and (ii) device classification information for a household electric appliance 5 shown in a captured image 7 to uniquely identify the household electric appliance 5.

For the present embodiment, the position information obtaining section 233 may omit the GPS receiver 2330 as long as the position information obtaining section 233 is capable of obtaining capturing position information.

[Terminal Information Obtaining Section 234]

The terminal information obtaining section 234 obtains, from the terminal information input section 22, information such as (i) terminal identification information such as an app ID and a password, (ii) character management information such as a character ID, an information ID, and character related information, and (iii) speech information.

An app ID refers to an ID of the terminal device 2 which ID is used to associate a character 8 having unique character management information with the terminal device 2 for registration as a pet character. An app ID is also an ID that identifies the user of the terminal device 2. A password refers to a password needed to register a character 8 as a pet character.

It is assumed, for instance, that the terminal information obtaining section 234 has received a voice from the terminal voice input section 220 of the terminal information input section 22. In this case, the terminal information obtaining section 234 converts the voice into text with use of a well-known voice recognition system. The terminal information obtaining section 234 then analyzes the text with use of a well-known technique to extract, for example, an app ID, a password, and the content of speech.

It is assumed that the terminal information obtaining section 234 has received text from the text input section 221 of the terminal information input section 22. The terminal information obtaining section 234, in this case, analyzes the text with use of a well-known technique to extract, for example, an app ID, a password, or the content of speech.

In a case where the user has touched a button at the terminal information input section 22, the terminal information obtaining section 234 determines that information indicated with the touched button is terminal information.

[Superimposed Image Generating Section 235]

The superimposed image generating section 235 obtains character management information via the terminal communication section 24. The superimposed image generating section 235 also refers to character management information and causes the display section 251 to superimpose an image of a character 8 over a captured image 7.

The superimposed image generating section 235 determines the position of display of the character 8 on the display section 251 in accordance with (i) device classification information of the household electric appliance 5 and (ii) the position of display of the household electric appliance 5 on the display section 251. The superimposed image generating section 235, for instance, causes the display section 251 to display an image of a character 8 so that the image of the character 8 is superimposed over or adjacent to the household electric appliance 5 (see FIG. 2). This gives the user the impression that the household electric appliance 5 and the character 8 are associated with each other.

More specifically, the superimposed image generating section 235 refers to character management information to generate model data and display position data, and generates a character 8 from the model data. Model data is, for example, polygon data on the basis of which a standing object is drawn with a combination of, for example, line segments and polygons. The superimposed image generating section 235 adjusts, according to the speech content determined by the terminal control section 23, data included in the model data which data indicates, for example, the position and orientation of the object and the respective angles of the neck, arms, and legs, and thereby generates a character 8.

The superimposed image generating section 235 superimposes an image of the character 8 over an image 7 captured by the image capturing section 21. The superimposed image generating section 235, for instance, carries out a rendering process on the polygon data of the character 8 to generate an image of the character 8 in accordance with the direction in which an image is captured of the household electric appliance 5.

Household electric appliances 5 having respective pieces of device identification information different from each other have respective pieces of character management information different from each other accordingly. For instance, it is assumed as shown in the character management DB 330 in FIG. 3 that the device classification information included in the device identification information indicates different items: “microwave oven” and “refrigerator”. In this case, the two household electric appliances 5, which have respective pieces of device classification information different from each other, are associated with respective characters having respective appearances different from each other accordingly as shown in the character management DB 330 in FIG. 3. This allows the superimposed image generating section 235 to cause the display section 251 to display images of characters 8 having respective appearances different from each other.

The superimposed image generating section 235 is, as described above, capable of causing the display section 251 to display images of different characters 8 in accordance with the device identification information.

[Terminal Communication Section 24]

The terminal communication section 24 is a radio communication interface for communication with the server communication section (communication section) 31 of the server 3 and the household electric appliance communication section 50 of a household electric appliance 5.

The terminal communication section 24 transmits, to the server 3, device identification information determined by the device identification information determining section 230 of the terminal control section 23.

As illustrated in FIG. 1, the terminal communication section 24 is in Wi-Fi (registered trademark) communication with a household electric appliance 5 via a wireless LAN communication device such as the wireless LAN router 6. The terminal communication section 24 includes a plurality of radio communication devices, and may have the function of wide-area radio communication based on, for example, LTE in addition to communicating with the wireless LAN router 6. As illustrated in FIG. 1, the terminal communication section 24 may, when communicating with the server 3, do so not via the wireless LAN router 6. In other words, the terminal communication section 24 may use wide-area radio communication to communicate with the server communication section 31 over the network 4.

The terminal communication section 24 and the household electric appliance communication section 50 may he configured to communicate directly with each other with use of, for example, Bluetooth (registered trademark) instead. of communicating with each other via the wireless LAN router 6.

[Presenting Section 25]

The presenting section 25 superimposes, over a captured image 7, an image of a character 8 that reflects character management information. The presenting section 25, as illustrated in FIG. 1 includes a terminal voice output section 250 and a display section 251.

[Terminal Voice Output Section 250]

The terminal voice output section 250 outputs voice.

Examples of the voice that the terminal voice output section 250 outputs include the content of speech by a character 8 for the user which content has been selected by the terminal control section 23 with reference to character management information.

For instance, it is assumed that different household electric appliances 5 sharing identical device classification information (“microwave oven”) among the pieces of device identification information have respective pieces of other device identification information different from each other. In this case, those household electric appliances 5, which have respective pieces of such other device identification information different from each other, are associated with respective pieces of character management information (such as character IDs) different from each other accordingly.

The above arrangement allows the terminal control section 23 to cause the terminal voice output section 250 to output, for example, “I am Abraham” in a case where the character ID is “CH_0001” and “I am Benjamin” in a case where the character ID is CH_0002. As described above, the terminal voice output section 250 is capable of outputting a different voice for each of a plurality of household electric appliances 5 that are associated with respective characters 8 having an identical appearance but have respective pieces of character management information different from each other as a whole such as respective character IDs different from each other.

As described above, the terminal voice output section 250 is capable of outputting a different voice in accordance with device identification information.

[Display Section 251]

The display section 251 displays, together with an image 7 captured of a household electric appliance 5, an image of a character 8 determined by the superimposed image generating section 235. In other words, the display section 251 displays a captured image 7 in which including a portion corresponding to an household electric appliance 5 over which portion an image of a character 8 is superimposed by the superimposed image generating section 235.

The display section 251 displays an image of a character 8 at a position determined by the superimposed image generating section 235. The display section 251 is, for example, a display.

[Server 3]

The description below deals with the configuration of the server 3 according to the present embodiment with reference to FIG. 1. As illustrated in FIG. 1, the server 3 according to the present embodiment includes a server communication section (communication section) 31, a server control section control section) 32, and a storage section 33.

The above example involves a single server 3. The present embodiment is, however, not limited to such a configuration. The present embodiment may be arranged such that at least one of the individual sections (functions) of the server 3 is provided by another server.

[Server Communication Section 31]

The server communication section 31 is communication interface for (i) communication with the terminal communication section 24 of the terminal device 2 over the network 4 and (ii) communication with the household electric appliance communication section 50 of a household electric appliance 5 via the wireless LAN router 6.

The server communication section 31 may communicate with the wireless LAN router 6 over the network 4. In a case where the terminal device 2 and a household electric appliance 5 communicate with each other directly, that is, not via the wireless LAN router 6, the server communication section 31 may communicate with the household electric appliance communication section 50 of the household electric appliance 5 via the terminal device 2.

The server communication section 31 obtains device identification information from the terminal communication section 24 of the terminal device 2. The server communication section 31 also transmits, to the terminal communication section 24 of the terminal device 2, character management information determined by the server control section (control section) 32.

[Server Control Section 32 and Storage Section 33]

The server control section 32 functions as a character management information determining section 320 and a device management information determining section 321.

[Character Management Information Determining Section 320]

The character management information determining section 320 refers to device identification information and determines character management information. The character management information determining section 320 also refers to the history of conversation between a character 8 and the user to update character management information.

More specifically, the character management information determining section 320 refers to the character management DB 330 included in the storage section 33 and thereby determines character management information corresponding to device identification information. The character management information determining section 320 also refers to the history of conversation between a character 8 and the user to update the character storage DB 331 of the storage section 33.

The character management information determining section 320 transmits, to the terminal device 2 via the server communication section 31, character management information that the character management information determining section 320 has determined.

The character management information determining section 320, which determines character management information corresponding to device identification information as described above, is capable of determining character management information related to a household electric appliance 5. The character management information determining section 320 is also capable of transmitting, to the terminal device 2 via the server communication section 31, character management information corresponding to device identification information. This allows the character management information determining section 320 to cause the terminal device 2 to superimpose, over a captured image 7, an image of a character 8 related to the household electric appliance 5. The character management information determining section 320 is thus capable of improving the relation between a household electric appliance 5 and a character 8.

The storage section 33, which includes a character management DB 330 to which the character management information determining section 320 refers, may be included in a server separate from the server 3 in which the character management information determining section 320 is included. In this case, the character management information determining section 320 is capable of referring, over the network 4, to the character management DB 330 of the storage section 33 included in the separate server. The character management DB 330 may be provided by a plurality of storage sections 33 or by a plurality of servers. This configuration makes it possible to determine character management information while reducing a load on a single server 3.

[Determining Character Management Information]

With reference to (a) of FIG. 3, the description below deals with how the character management information determining section 320 of the server control section 32 determines character management information.

(a) of FIG. 3 is a graph illustrating an example character management DB 330 stored in the storage section 33 of the server 3.

It is assumed that the character management information determining section 320 has obtained at least either a device ID or capturing position information as device identification information other than device classification information. In this case, the character management information determining section 320 searches the character management DB 330 in (a) of FIG. 3 for (i) information on the appearance of the character associated with the device classification information and (ii) the character ID associated with the device ID or capturing position information.

It is assumed, for instance, that the device classification information indicates “microwave oven” and that the device ID is HE_1.212. In this case, the character management information determining section 320 determines, as character management information, information indicating that the appearance of the character is that of Joe Microwave and that the character ID is CH_0001.

Similarly, it is assumed that the device classification information indicates “microwave oven” and that the capturing position information indicates latitude 35.6°, longitude 140.0°, and altitude 30 m. In this case, the character management information determining section 320 determines, as character management information, information indicating that the appearance of the character is that of Joe Microwave and that the character ID is CH_0001.

It is assumed that the character management information determining section 320 has obtained neither a device ID nor capturing position information other than device classification information or that a device ID and capturing position information are associated with no character ID. In this case, the character management information determining section 320 determines information on only the appearance of a character as character management information for determining a character 8. In other words, only information on the appearance of a character is reflected as information for determining a character 8.

A case where a device ID and capturing position information are associated with no character ID refers to, for instance, a case where the character management DB 330 in (a) of FIG. 3 has a blank field for a character ID associated with the device ID and capturing position information.

In a case where only the appearance of a character is reflected as information for determining a character 8, such pieces of character management information as the content of speech and clothes are determined from typical options. This is because a character ID is not reflected in the character 8.

It is assumed, for instance, that the appearance of a character is that of Joe Microwave, which personifies a microwave oven as illustrated in FIG. 2. In this case, Joe Microwave says, for example, “I am Joe Microwave ”, which does not identify the character 8 as compared to, for example, “I am Abraham ”. Further, in this case, Joe Microwave wears an apron as illustrated in FIG. 2. Joe Microwave wears something that can, in comparison to wearing a down jacket, be easily associated with the household electric appliance 5 on which the appearance is based.

It is assumed, for instance, that the device classification information indicates “microwave oven ”. In this case, the character management information determining section 320 determines, as character management information, information indicating that the appearance of the character is that of Joe Microwave. As described above, the character management information determining section 320 is capable of determining character management information related to a household electric appliance 5 even in a case where the character management information determining section 320 has not obtained device identification information other than device classification information.

[Determining Character Management Information: Variation 1]

The character management information determining section 320 does not necessarily determine information on only the appearance of a character as character management information for determining a character 8. The character management information determining section 320 may instead create a new character ID to be included in the character management DB 330. This allows the character management information determining section 320 to determine, as character management information, information including information on the appearance of a character and a newly created character ID.

[Determining Character Management Information: Variation 2]

In the above example, the character management information determining section 320 refers to device identification information in the character management DB 330 in (a) of FIG. 3 to determine character management information. The present embodiment is, however, not limited to such an arrangement. The present embodiment may be arranged such that the character management information determining section 320 determines character management information without referring to device identification information.

Character management information includes not only a character ID and information on the appearance of a character as shown in (a) of FIG. 3 but also an information ID and character related information as shown in (b) of FIG. 3. The character management information determining section 320 is thus capable of referring to the character storage DB 331 in (b) of FIG. 3 to determine character management information.

The character management information determining section 320 is, for instance, capable of determining, with reference to the character storage DB 331, character related information associated with a character ID and an information ID both obtained from the terminal device 2. This allows the character management information determining section 320 to transmit, to the terminal device 2 via the server communication section 31, character management information including character related information that the character management information determining section 320 has determined. This in turn allows the terminal control section 23 of the terminal device 2 to cause the presenting section 25 to present the user with a character 8 that reflects character related information.

[Updating Character Management Information]

The character management information determining section 320 is capable of not only determining character management information but also updating character management information.

In other words, the determination of character management information by the character management information determining section 320 is not limited to determining character management information already included in either the character management DB 330 or the character storage DB 331. The determination of character management information by the character management information determining section 320 includes newly adding character management information to either the character management DB 330 or the character storage DB 331.

With reference to (b) of FIG. 3, the description below deals with how the character management information determining section 320 updates character management information.

Before dealing with how the character management information determining section 320 updates character management information, the description below first deals with the character storage DB 331 in (b) of FIG. 3 stored in the storage section 33 of the server 3.

[Character Storage DB 331]

(b) of FIG. 3 is a graph illustrating an example character storage DB 331.

As described above, the information ID shown in (b) of FIG. 3 indicates the type of information that a character 8 stores. For instance, among the information IDs included in the character storage DB 331 in (b) of FIG. 3, the value “1” as an information ID indicates that the character related information indicates a favorite food of the user's; the value “2” as an information ID indicates that the character related information indicates what the user does; the value “10” as an information ID indicates that the character related information indicates whose place the character 8 lives in; the value “20” as an information ID indicates that the character related information indicates what the character8 is currently doing; and the value “38” as an information ID indicates that the character related information indicates the user's birthday.

As described above, character related information in (b) of FIG. 3 refers to details of information on the character 8 for the information ID. The character storage DB 331 in (b) of FIG. 3 shows, for instance, that the value “1” as an information ID (favorite food of the user's) is associated with “fish” as character related information. The character management information is thus defined as indicating that a favorite food of the user's is fish.

The character storage DB 331 in (b) of FIG. 3 has blank fields under “App ID ”, each of which indicates that the character related information is information on the character 8 itself.

[Updating Character Management Information: Specific Example 1]

On the basis of the above description, the description below deals with a specific example of how the character management information determining section 320 updates character management information.

For instance, it is assumed that the terminal control section 23 has caused a character 8 in which CH_0001 as a character ID has been reflected to ask the user the question “What food do you like?”. It is also assumed that the character management information determining section 320 has obtained the replay “I like fish” from the terminal device 2 of the user's via the server communication section 31. In this case, the character management information determining section 320 extracts the keyword “fish” from the reply “I like fish ”.

The character management information determining section 320 then associates “1” as an information ID (favorite food of the user's related to the question “What food do you like?” by the character 8 with “fish” extracted from the user's reply. In other words, the character management information determining section 320 sets character related information associated with CH_0001 as a character ID and “1” as an information ID to indicate “fish ”.

The character management information determining section 320 then reflects such association in the character storage DB 331 as shown in the character storage DB 331 in (b) of FIG. 3. This updates the character management information in the character storage DB 331.

[Updating Character Management Information: Specific Example 2]

In the above example, the terminal control section 23 causes a character 8 in which CH_0001 as a character ID has been reflected to ask the user a question related to a particular information ID. The character management information determining section 320 then refers to a reply to that question by the user to determine character management information.

The present embodiment is, however, not limited to such an arrangement. The present embodiment may be arranged such that the character management information determining section 320 determines character management information on the basis of a character ID obtained from the terminal device 2 of the user's, an information ID, and character related information.

The character management information determining section 320 may directly obtain, as character management information such as a character ID, an information ID, and character related information, information that the user has inputted on the text input section 221. It is assumed, for instance, that the user did not directly input an information ID and character related information into the terminal information input section 22, but has said “My favorite food is fish ”. In this case, the character management information determining section 320 may set an information ID to “1” (favorite food of the user's) and character related information to “fish” on the basis of the reply by the user.

As described above, the character management information determining section 320 is capable of updating character management information in the character storage DB 331 even in a case where the character management information determining section 320 has obtained a character ID, an information ID, and character related information.

[Device Management Information Determining Section 321]

The device management information determining section 321 refers to character management information and determines device management information.

More specifically, the device management information determining section 321 refers to character management information and the device management DB 332 to determine device management information. The determination of device management information includes updating device management information on the basis of newly obtained information similarly to the above-described determination of character management information.

The device management information determining section 321 transmits, to a household electric appliance 5 via the server communication section 31, device management information that the device management information determining section 321 has determined.

The device management information determining section 321, which refers to character management information and determines device management information as described above, is capable of allowing a household electric appliance 5 to refer to information related to information that a character 8 has. The device management information determining section 321 is also capable of transmitting, to the terminal device 2, device management information that the device management information determining section 321 has determined with reference to character management information. This allows the terminal control section 23 of the terminal device 2 to refer to device management information and cause an image of a character 8, which image is related to information that the character 8 has, to be superimposed over a captured image 7. As described above, the device management information determining section 321 determining device management information allows the relation between a household electric appliance 5 and a character 8 to be improved further.

(Determining Device Management Information)

With reference to the device management DB 332 in (c) of FIG. 3, the description below deals with how the device management information determining section 321 determines and updates character management information.

Before dealing with how the device management information determining section 321 updates device management information, the description below first deals with the device management DB 332 in (c) of FIG. 3 stored in the storage section 33 of the server 3.

(Device Management DB 332)

(c) of FIG. 3 is a graph illustrating an example device management DB 332.

As shown in the device management DB 332 in (c) of FIG. 3, device management information includes device classification information, a device ID, device operation information, and device stored information. As such, device management information includes a portion of device identification information described above, and allows an individual household electric appliance 5 to be identified and the form of presenting a character 8 to be determined. Device classification information and a device ID are similar to those included in device identification information described above, and are thus not described here again.

Device operation information is information related to operation of a household electric appliance 5 shown in a captured image 7. More precisely, device operation information is information indicative of the current operating state of a household electric appliance 5. Device operation information is related to “20” as an information ID (what the character 8 is currently doing) in the character storage DB 331 in (b) of Table 3. Device stored information is information to which a household electric appliance 5 refers for operation. Device stored information is related to an information ID and character related information in the character storage DB 331. As is clear from (c) of FIG. 3, device operation information and device stored information each include a combination of a plurality of pieces of information tupled and stored in the device management DB 332, and can each be updated at any time for addition.

(Determining Device Management Information: Specific Example 1)

On the basis of the above description, the description below deals with a specific example of how the device management information determining section 321 determines device management information.

For instance, it is assumed as described above that the terminal control section 23 has caused a character 8 in which CH_001 as a character ID has been reflected to ask the user the question “What food do you like?”. It is also assumed that the character management information determining section 320 has obtained the replay “I like fish” from the terminal device 2 of the user's via the server communication section 31. In this case, the character management information determining section 320 associates CH_0001 as a character ID, “1” as an information ID (favorite food of the user's), and “fish” as character related information with one another, and updates the character storage DB 331.

In this case, the device management information determining section 321 refers to an information ID and character related information in the character management DB 330 and adds “favorite food of the user's: fish” as device stored information inn the device management DB 332. The device management information determining section 321 then determines, among different pieces of device operation information that are associated with “favorite food of the user's: fish” as device stored information, “recipe suggestion” as device operation information.

It is assumed that the user has said to the household electric appliance 5, “What should I cook today?”. In this case, the device management information determining section 321 associates “recipe suggestion” as device operation information and “favorite food of the user's: fish” as device stored information with each other, and sets device management information to “How about a mackerel boiled with soybean paste?”. The device management information determining section 321 transmits the device management information to the household electric appliance 5 via the server communication section 31, and causes the household electric appliance voice output section 521 to output the device management information.

The above arrangement allows the device management information determining section 321 to cause the household electric appliance 5 to reply, “How about a mackerel boiled with soybean paste?” to “What should I cook today?”, which the user has said to the household electric appliance 5. The device management information determining section 321 is also capable of allowing the household electric appliance 5 to refer to character management information of the character 8 having the character ID “CH_0001 ”.

As described above, the device management information determining section 321 is capable of, in response to what the user has said to a household electric appliance 5, (i) referring to character management information of a character 8 having a particular character ID and thereby (ii) determining device management information. The device management information determining section 321 is also capable of, in response to what the user has said to a household electric appliance 5, allowing the household electric appliance 5 to refer to character management information of a character 8 having a particular character ID.

(Determining Device Management Information: Specific Example 2)

In the example described above, the device management information determining section 321 causes a household electric appliance 5 to output device management information that the device management information. determining section 321 has determined in response to what the user has said to the household electric appliance 5. The present embodiment is, however, not limited to such an arrangement. The present embodiment may be arranged such that the device management information determining section 321 causes a household electric appliance 5 to output device management information that the device management information determining section 321 has determined on its own, that is, not in response to what the user has said to the household electric appliance 5.

It is assumed, for instance, that a character 8 displayed by the terminal device 2 has the character ID “CH_0001” and that a household electric appliance 5 has the device ID “HE_1212 ”. In this case, the device management information determining section 321 associates (i) “recipe suggestion” as device operation information associated with the device ID “HE_1212” in the device management DB 332 in (b) of FIG. 3 and (ii) “user's birthday: June 6” as device stored information in the device management DB 332 with each other.

As a result, the device management information determining section 321 sets device management information to “Isn't today your birthday? Let's have a feast!”. Subsequently, the device management information determining section 321 transmits the device management information to the household electric appliance 5 having the device ID “HE_1212 ”. The device management information determining section 321 then causes the household electric appliance voice output section 521 of the household electric appliance 5 to say to the user, “Isn't today your birthday? Let's have a feast!”. In other words, the device management information determining section 321 is capable of allowing the household electric appliance 5 to refer to character management information of the character 8 having the character ID “CH_0001 ”.

As described above, the device management information determining section 321 is capable of, on its own, referring to character management information of a character 8 having a particular character ID and thereby determining device management information. The device management information determining section 321 is also capable of, on its own, allowing the household electric appliance 5 to refer to character management information of a character 8 having a particular character ID.

The description below under “Information providing process” deals in greater detail with a process through which the device management information determining section 321 causes a household electric appliance 5 to refer to character management information.

[Information Providing Process]

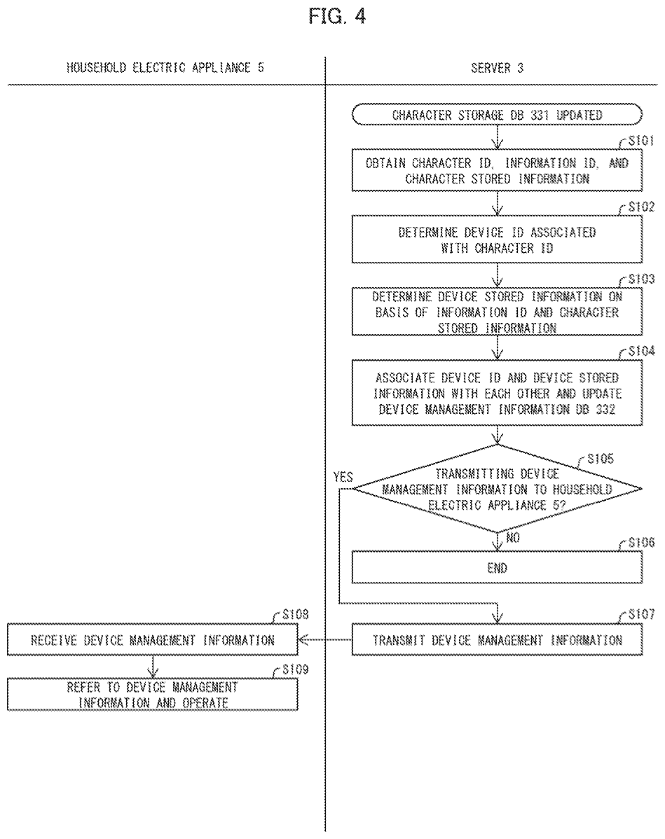

With reference to FIG. 4, the description below deals with an information providing process (information providing method) carried out by the display system 1 according to the present embodiment. FIG. 4 is a sequence diagram illustrating an example flow of the information providing process carried out by the display system 1 according to the present embodiment.

The display system 1 according to the present embodiment carries out an information providing process by carrying out the below-described steps S101 to S109.

Step S101: In a case where the character storage DB 331 in (b) of FIG. 3 has been updated, the server 3 first refers to the character storage DB 331. The server 3 then obtains a character ID, an information ID, and character related information that have been newly added to the character storage DB 331.

Step S102: Next, the server 3 refers to the character management DB 330 in (a) of FIG. 3 and obtains the device ID associated with the character ID.

Step S103: The device management information determining section 321 of the server 3 determines device stored information on the basis of the information ID and character related information obtained.

In a case where, for instance, the information ID is “1” (favorite food of the user's) and the character related information indicates “fish ”, the device management information determining section 321 of the server 3 sets device stored information to “favorite food of the user's: fish ”.

Step S104: The device management information determining section 321 of the server 3 refers to the device management DB 332 in (c) of FIG. 3 to associate the device ID and the above-set device stored information with each other. This allows the device management information determining section 321 of the server 3 to determine and update device management information. The device management DB 332 is updated as a result.

As described above, the device management information determining section 321 of the server 3 is capable of referring to character management information and updating device management information even iii a case where the device management information is not preset. The device management information determining section 321 of the server 3 thus allows the relation between a household electric appliance 5 and a character 8 to be improved further.

Step S105: In a case where the device management information determining section 321 of the server 3 is to transmit the updated device management information to the household electric appliance 5 (YES in step S105), the process goes to step S107. In a case where the device management information determining section 321 of the server 3 is not to transmit the updated device management information to the household electric appliance 5 (NO in step S105), the process goes to step S106.

Step S106: In the case where the device management information determining section 321 is not to transmit device management information to the household electric appliance 5, the information providing process ends.

Step S107: The device management information determining section 321 of the server 3 transmits the updated device management information to the household electric appliance 5 via the server communication section 31 (device management information determining step). In other words, the device management information determining section 321 of the server 3 causes the household electric appliance 5 to refer to the device management information and instructs the household electric appliance 5 to carry out a particular operation.

Step S108: The household electric appliance 5 receives the device management information from the server 3 via the household electric appliance communication section 50.

Step S109: The household electric appliance 5 refers to the device management information received and operates.

[Information Providing Process: Variation 1]

The information providing process (through which the device management information determining section 321 of the server 3 in the display system 1 causes a household electric appliance 5 to refer to character management information) is not limited to the above example. The device management information determining section 321 of the server 3 is capable of carrying out an information providing process even in a case other than the case where the character storage DB 331 has been updated.

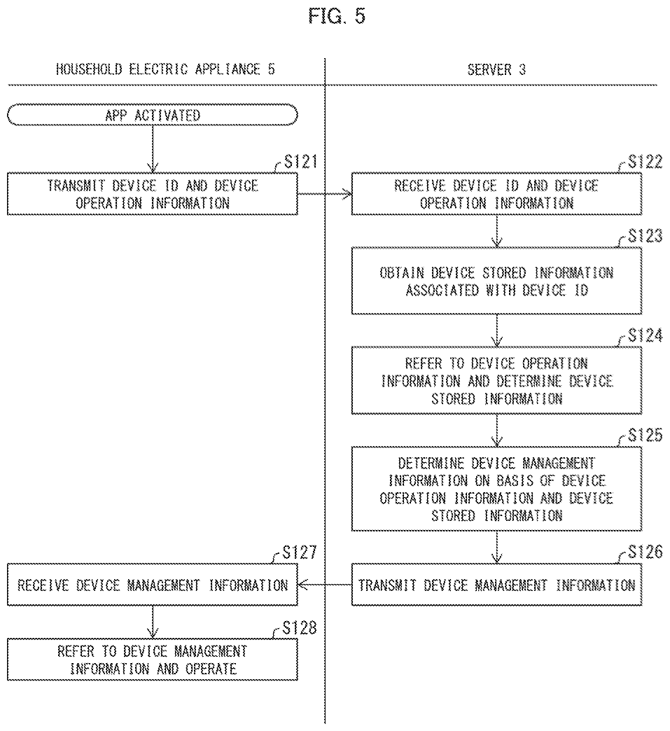

With reference to FIG. 5, the description below deals with Variation 1 of the information providing process carried out by the display system 1 according to the present embodiment. FIG. 5 is a sequence diagram illustrating an example flow of the information providing process carried out by the display system 1 according to the present embodiment.

The display system 1 according to the present embodiment can carry out an information providing process by carrying out the below-described steps S121 to S128 as well.

Step S121: The description below deals with a case where an operation section 52 of a household electric appliance 5 has accepted a press on a button or the like by the user, and the household electric appliance 5 has thus activated an app that uses character management information.

In a case where the household electric appliance 5 is to refer to character management information and say something to the user on its own, the household electric appliance 5 first transmits the device ID and device operation information of its own to the server 3 via the household electric appliance communication section 50.

Step S122: The device management information determining section 321 of the server 3 receives the device ID and device operation information from the household electric appliance 5 via the server communication section 31.

Step S123: The device management information determining section 321 of the server 3 refers to the device management DB 332 in (c) of FIG. 3. It is assumed that the device management DB 332 already includes the device ID and device operation information received. In this case, the device management information determining section 321 determines that the household electric appliance 5 is requesting information such as device stored information already included in the device management DB 332. The device management information determining section 321 obtains device stored information associated with the device ID. As is clear from (c) of FIG. 3, the device stored information includes a plurality of pieces of information such as “favorite food of the user's: fish ”, “food disliked by the user: vegetables ”, “weather: fine ”, and “user's birthday: June 6 ”.

In a case where the device ID and device operation information received are not included in the device management DB 332, the device management information determining section 321 determines that the household electric appliance 5 is requesting to update information. In this case, the device management information determining section 321 adds, to the device management DB 332, the device ID and any piece of the device operation information that is not described for the device management information determining section 321.

Step S124: The device management information determining section 321 of the server 3 refers to the particular device operation information obtained from the household electric appliance 5. The device management information determining section 321 then selects, from among a plurality of pieces of device stored information, that piece of device stored information which is related to the particular device operation information, and determines that piece of device stored information. In a case where, for instance, the device operation information indicates “recipe suggestion ”, the device management information determining section 321 of the server 3 sets device stored information to “favorite food of the user's: fish” among the plurality of pieces of device stored information.

Step S125: The device management information determining section 321 of the server 3 associates the obtained device operation information and the above-set device stored information with each other, and determines device management information.

It is assumed, for instance, that the household electric appliance 5 having the device ID “HE_1212” associated with the character ID “CH_0001” has obtained device operation information indicative of “recipe suggestion” and that the device stored information determined indicates “favorite food of the user's: fish ”. In this case, the device management information determining section 321 of the server 3 sets device management information to “How about a mackerel boiled with soybean paste?”.

Step S126: The device management information determining section 321 of the server 3 transmits the above-set device management information to the household electric appliance 5 via the server communication section 31 (device management information determining step). In other words, the device management information determining section 321 of the server 3 causes the household electric appliance 5 to refer to the device management information and instructs the household electric appliance 5 to carry out a particular operation.

For instance, the device management information determining section 321 of the server 3 instructs the household electric appliance voice output section 521 of the household electric appliance 5 to say, “How about a mackerel boiled with soybean paste?”.

Step S127: The household electric appliance 5 receives the device management information from the server 3 via the household electric appliance communication section 50.

Step S128: The household electric appliance 5 refers to the device management information received and operates.

As described above, a household electric appliance 5 transmitting its device ID and device operation information to the server 3 allows the device management information determining section 321 to instruct the household electric appliance 5 to, for instance, say something specific.

[Information Providing Process: Variation 2]

The device management information determining section 321 of the server 3 in the display system 1 is capable of carrying out an information providing process even in the case below.

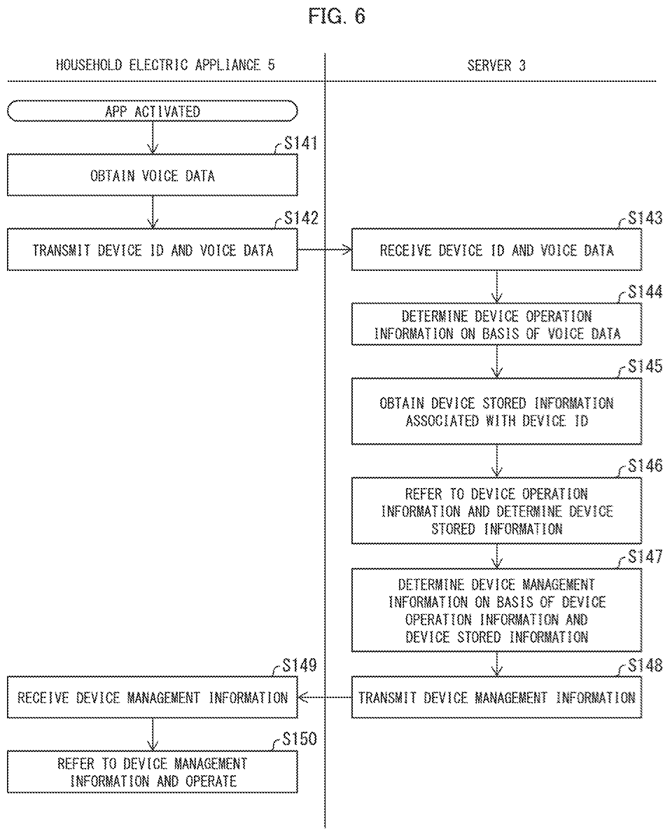

With reference to FIG. 6, the description below deals with Variation 2 of the information providing process carried out by the display system 1 according to the present embodiment. FIG. 6 is a sequence diagram illustrating an example flow of the information providing process carried out by the display system according to the present embodiment.

The display system 1 according to the present embodiment can carry out an information providing process by carrying out the below-described steps S141 to S150 as well.

Step S141: The description below deals with a case where an operation section 52 of a household electric appliance 5 has accepted a press on a button or the like by the user, and the household electric appliance 5 has thus activated an app that uses character management information.

It is assumed that a household electric appliance 5 has first accepted a voice input such as a vocal question by the user. This causes a household electric appliance control section 51 of the household electric appliance 5 to obtain voice data via a household electric appliance voice input section 520.

Step S142: The household electric appliance control section 51 of the household electric appliance 5 transmits, to the device management information determining section 321 of the server 3 via the household electric appliance communication section 50, the device ID of the household electric appliance 5 and the voice data obtained.

Step S143: The device management information determining section 321 of the server 3 receives the device ID and voice data from the household electric appliance 5 via the server communication section 31.

Step S144: The device management information determining section 321 of the server 3 determines device operation information from the voice data with use of a well-known voice recognition system. In a case where, for instance, the voice data indicates “What should I cook today?”, the device management information determining section 321 of the server 3 extracts the keywords“what” and “cook” from the voice data. Subsequently, the device management information determining section 321 of the server 3 refers to the device management DB 332 in (c) of FIG. 3. The device management information determining section 321 of the server 3 then selects, from among a plurality of pieces of device operation information, the device operation information “recipe suggestion ”, which belongs in a field similar to the respective fields of the keywords.

Step S145: The device management information determining section 321 of the server 3 refers to the device management DB 332 in (c) of FIG. 3, and obtains a plurality of device stored information associated with the device ID obtained. In a case where, for instance, the device is “HE_1212 ”, the device management information determining section 321 of the server 3 obtains such pieces of device stored information as “favorite food of the user's: fish ”, “food disliked by the user: vegetables ”, “weather: fine ”, and “user's birthday: June 6 ”.

Step S146: The device management information determining section 321 of the server 3 selects, from among a plurality of device stored information, that piece of device stored information which is related to the device operation information, and determines that piece of device stored information. In a case where, for instance, the device operation information indicates “recipe suggestion ”, the device management information determining section 321 sets device stored information to “favorite food of the user's: fish” among the plurality of pieces of device stored information.

Step S147: The device management information determining section 321 of the server 3 associates the obtained device operation information and the above-set device stored information with each other, and determines device management information. It is assumed, for instance, that the household electric appliance 5 having the device ID “HE_1212” associated with the character ID “CH_0001” has obtained device operation information indicative of “recipe suggestion” and that the device stored information determined indicates “favorite food of the user.'s: fish ”. In this case, the device management information determining section 321 sets device management information to “How about a mackerel boiled with soybean paste?”.

Step S148: The device management information determining section 321 of the server 3 transmits the above-set device management information to the household electric appliance 5 via the server communication section 31 (device management information determining step). In other words, the device management information determining section 321 of the server 3 causes the household electric appliance 5 to refer to the device management information and instructs the household electric appliance 5 to carry out a particular operation. For instance, the device management information determining section 321 of the server 3 instructs the household electric appliance voice output section 521 of the household electric appliance 5 to say, “How about a mackere1 boiled with soybean paste?”.

Step S149: The household electric appliance 5 receives the device management information from the server 3 via the household electric appliance communication section 50.

Step S150: The household electric appliance 5 refers to the device management information received and operates.

With the above arrangement, the device management information determining section 321 of the server 3 in the display system 1 is capable of, in a case where a household electric appliance 5 has accepted a voice input, causing the household electric appliance 5 to (i) refer to character management information and (ii) carry out an operation such as saying something.

[Information Providing Process: Variation 3]

The device management information determining section 321 of the server 3 is capable of carrying out an information providing process even in the case below.

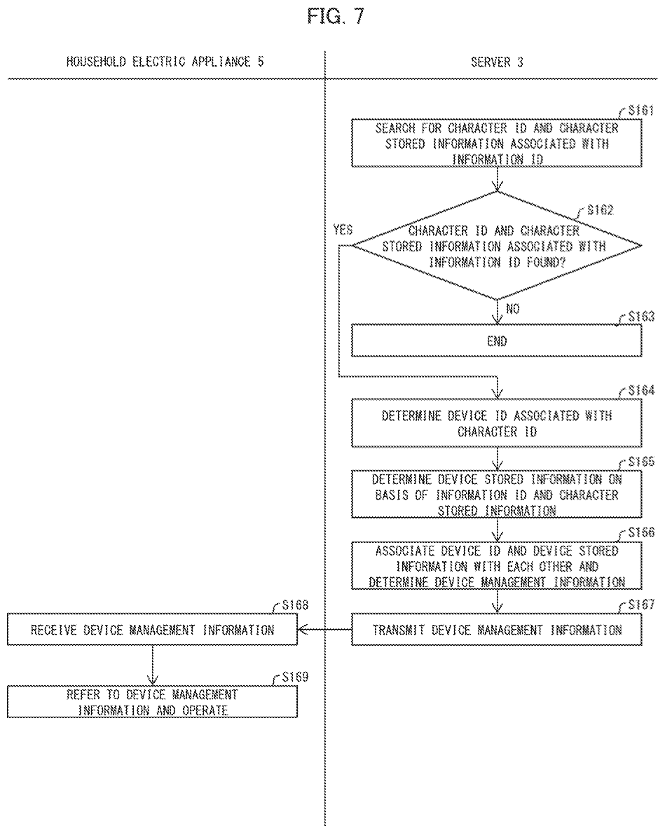

With reference to FIG. 7, the description below deals with Variation 3 of the information providing process carried out by the display system 1 according to the present embodiment. FIG. 7 is a sequence diagram illustrating an example flow of the information providing process carried out by the display system 1 according to the present embodiment.

The display system 1 according to the present embodiment can carry out an information providing process by carrying out the below-described steps S161 to S169 as well.

Step S161: The description below deals with a form of the server 3 providing an operation instruction a household electric appliance 5 at regular intervals such as every day or at a particular time such as a time of issue of a prompt earthquake report and the user's birthday.

First, the device management information determining section 321 of the server 3 selects an information ID for the character storage DB 331 in (b) of FIG. 3. The device management information determining section 321 of the server 3 also searches the character storage DB 331 for the character ID and character related information associated with the information ID.

In a case where, for instance, today is the user's birthday, the device management information determining section 321 of the server 3 refers to the character storage DB 331 and searches for the character ID and character related information associated with the information ID “38” (user's birthday).

Step S162: In a case where the device management information determining section 321 of the server 3 has found the character ID and character related information associated with the information ID (YES in step S162), the process goes to step S164. In a case where the device management information determining section 321 of the server 3 did not find the character ID and character related information associated with the information ID (NO in step S162), the process goes to step S163.

In a case where, for example, the information ID is “38” (birthday), the device management information determining section 321 of the server 3 determines that the character ID is “CH_0004” and that the character related information is “June 6”.

The case where the device management information determining section 321 of the server 3 did not find the character ID and character related information associated with the information ID is a case where the character storage DB 331 has a blank field for at least either the character ID or the character related information each in association with the information ID.

Step S163: In the case where the device management information determining section 321 of the server 3 did not find the character ID and character related information associated with the information ID, the process ends.

Step S164: The device management information determining section 321 of the server 3 refers to the character management DB 330 in (a) of FIG. 3 and determines the device ID associated with the character ID.

Step S165: The device management information determining section 321 of the server 3 determines device stored information on the basis of the information ID and character related information obtained.

In a case where, for instance, the information ID is “38” (user's birthday) and the character related information indicates “June 6”, the device management information determining section 321 of the server 3 sets device stored information to “user's birthday: June 6 ”.

Step S166: The device management information determining section 321 of the server 3 refers to the device management DB 332 in (c) of FIG. 3 to associate the device ID and the device stored information with each other. This allows the device management information determining section 321 of the server 3 to determine device management information.

In a case where, for instance, the device ID is “HE_1212” and the device stored information indicates “user's birthday: June 6”, the device management information determining section 321 of the server 3 sets device management information to “Isn't today your birthday? Let's have a feast!”.

Step S167: The device management information determining section 321 of the server 3 transmits the above-set device management information to the household electric appliance 5 via the server communication section 31 (device management information determining step). In other words, the device management information determining section 321 of the server 3 causes the household electric appliance 5 to refer to the device management information and instructs the household electric appliance 5 to carry out a particular operation.

For instance, the device management information determining section 321 of the server 3 instructs the household electric appliance voice output section 521 of the household electric appliance 5 to say, “Isn't today your birthday? Let's have a feast!”.

Step S168: The household electric appliance 5 receives the device management information from the server 3 via the household electric appliance communication section 50.

Step S169: The household electric appliance 5 refers to the device management information received and operates.

As described above, the device management information determining section 321 of the server 3 is capable of causing a household electric appliance 5 to (i) refer to character management information at a particular time and (ii) carry out an operation on its own such as saying something.

As described above, the server 3 according to the present embodiment is a server 3 for providing information to a terminal device 2 configured to superimpose an image of a character 8 over a captured image 7, the server 3 including a server communication section 31 and a server control section 32, the server control section 32 being configured to (i) refer to device identification information for identifying an individual household electric appliance 5 shown in the captured image 7 and (ii) determine character management information for managing the form of presenting the character 8, and transmit the determined character management information to the terminal device 2 via the server communication section 31, or refer to the character management information and determine device management information for determining a state that the individual household electric appliance 5 presents, and transmit the determined device management information to the individual household electric appliance 5 via the server communication section 31.

The server control section 32 of the server 3 transmits, to the terminal device 2, character management information determined with reference to device identification information or transmits, to the household electric appliance 5, device management information determined with reference to character management information. This allows the form of presenting the character 8 and the state that the household electric appliance 5 presents to be related to each other. With this arrangement, the server 3 allows the relation between a character 8 and a household electric appliance 5 to be improved further.

The server 3 according to the present embodiment is arranged such that the server control section 32 is configured to carry out control of either referring to the device identification information and updating the character management information, or referring to the character management information and updating the device management information.

The server control section 32 of the server 3 is capable of referring to device identification information and updating character management information even in a case where the character management information is not preset. The server control section 32 of the server 3 is also capable of referring to character management information and updating device identification information even in a case where the device identification information is not preset. With this arrangement, the server 3 allows the relation between a character 8 and a household electric appliance 5 to be improved further.

The server 3 according to the present embodiment is arranged such that the device identification information includes device classification information, which is classification information obtainable from the appearance of a household electric appliance 5 shown in a captured image 7.

The server control section 32 of the server 3 is capable of determining character management information related to device classification information among different pieces of device identification information. The server control section 32 of the server 3 is also capable of transmitting, to the terminal device 2, character management information associated with device classification information. With this arrangement, the server 3, which includes the server control section 32, is capable of causing the terminal device 2 to superimpose, over a captured image 7, an image of a character 8 related to device classification information for a household electric appliance 5. With the above arrangement, the server 3 allows the relation between a household electric appliance 5 and a character 8 to be improved further.

The server 3 according to the present embodiment is arranged such that the device identification information includes capturing position information of a captured image

The server control section 32 of the server 3 is capable of determining character management information related also to capturing position information among different pieces of device identification information. The server control section 32 of the server 3 is also capable of transmitting, to the terminal device 2, character management information associated with device classification information as well as capturing position information. With this arrangement, the server 3, which includes the server control section 32, is capable of causing the terminal device 2 to superimpose, over a captured image 7, an image of a character 8 related also to capturing position information for a household electric appliance 5. With the above arrangement, the server 3 allows the relation between a household electric appliance 5 and a character 8 to be improved further.

The server 3 according to the present embodiment is arranged such that the device identification information further includes a device ID obtainable through communication with a household electric appliance 5 shown in a captured image 7.

The server control section 32 of the server 3 is capable of determining character management information related also to a device ID among different pieces of device identification information. The server control section 32 of the server 3 is also capable of transmitting, to the terminal device 2, character management information associated with a device ID as well as device classification information. With this arrangement, the server 3, which includes the server control section 32, is capable of causing the terminal device 2 to superimpose, over a captured image 7, an image of a character 8 related also to the device ID of a household electric appliance 5. With the above arrangement, the server 3 allows the relation between a household electric appliance 5 and a character 8 to be improved further.

The terminal device 2 according to the present embodiment is a terminal device 2 including: an image capturing section 21; a presenting section 25; a terminal control section 23; and a terminal communication section 24, the presenting section 25 including a display section 251, the terminal control section 23 being configured to carry out control of at least either (i) obtaining, from a server 3 for providing information to the terminal device 2, character management information for managing a form of presenting a character 8 which character management information has been determined with reference to device identification information for identifying an individual household electric appliance 5 shown in a captured image 7 and (ii) causing the display section 251 to superimpose an image of the character 8 over the captured image 7 captured by the image capturing section 21, or transmitting the device identification information for identifying the individual household electric appliance 5 to the server 3 via the terminal communication section 24.

The terminal device 2 according to the present embodiment is capable of superimposing, over a captured image 7, an image of a character 8 related to a household electric appliance 5. With this arrangement, the terminal device 2 allows the relation between a household electric appliance 5 and a character 8 to be improved further.

The terminal device 2 according to the present embodiment is arranged such that the device identification information is associated with the character management information, which is referred to for determining device management information for determining a state that the individual household electric appliance 5 presents.

In a case where the device identification information is associated with the character management information, which is referred to for determining device management information for determining a state that the individual household electric appliance 5 presents, the relation between a household electric appliance 5 and a character 8 is improved further.

The display system 1 according to the present embodiment is a display system 1 including: a server 3; and a terminal device 2, the terminal device 2 including: an image capturing section 21; a presenting section 25; a terminal control section 23; and a terminal communication section 24, the server 3 including a server communication section 31 and a server control section 32, the server control section 32 being configured to carry out control of at least either (i) referring to device identification information for identifying an individual household electric appliance 5 shown in a captured image 7 and (ii) determining character management information for managing a form of presenting a character 8, and transmitting the determined character management information to the terminal device 2 via the server communication section 31, or referring to the character management information and determining device management information for determining a state that the individual household electric appliance 5 presents, and transmitting the determined device management information to the individual household electric appliance 5 via the server communication section 31, the terminal control section 23 being configured to refer to the character management information and cause the display section 251 to superimpose an image of the character 8 over the captured image 7 captured by the image capturing section 21.

The display system 1 according to the present embodiment is capable of superimposing, over a captured image 7, an image of a character 8 related to a household electric appliance 5. With this arrangement, the display system 1 allows the relation between a household electric appliance 5 and a character 8 to be improved further.

The information providing method according to the present embodiment is an information providing method for providing information to a terminal device 2 configured to superimpose an image of a character 8 over a captured image 7, the information providing method including at least either: (i) referring to device identification information for identifying an individual household electric appliance 5 shown in a captured image 7 and (ii) determining character management information for mar aging a form of presenting a character 8, and transmitting the determined character management information to the terminal device 2, or referring to the character management information and determining a state that the individual household electric appliance 5 presents, and transmitting the determined device identification information to the individual household electric appliance 5.

The information providing method according to the present embodiment is capable of superimposing, over a captured image 7, an image of a character 8 related to a household electric appliance 5. With this arrangement, the information providing method allows the relation between a household electric appliance 5 and a character 8 to be improved further.

### Embodiment 2

Embodiment 1 is arranged such that the server control section 32 of the server 3 refers to character management information to determine device management information. The server control section may have a function in place of or in addition to the function of the server control section 32 as a server control section 34 (not shown) of a server 30 (not shown) for Embodiment 2.

[Display System 10]

The display system 10 (not shown) according to the present embodiment includes a server 30 in place of the server 3. The server 30 includes a server control section 34 in place of the server control section 32. The server control section 34 includes a character management information determining section 340 in place of the character management information determining section 320. The server 30 is similar in configuration to the server 3 except for the above points.

[Server 30]

The server 30 includes a server control section 34.

The character management information determining section 340 of the server control section 34 has a function in addition to the function of the character management information determining section 320 of the server control section 32. The additional function is the function of referring to device management information and determining character management information.

The character management information determining section 340 refers to device management information to determine character management information, and transmits the character management information to the terminal device 2. This allows an image of a character 8 superimposed over an image 7 captured by the terminal device 2 to be related to the state that a household electric appliance 5 presents. The character management information determining section 340 is capable of causing an image of a character 8 related to a household electric appliance 5 to be superimposed over a captured image 7 as described above.

More specifically, the character management information determining section 340 changes, in accordance with device operation information, the form of presenting a character 8.

With the above arrangement, the character management information determining section 340 is capable of causing operation of a household electric appliance 5 and action of a character 8 to be in real-time conjunction with each other.

[Function of Character Management Information Determining Section 340: Specific Example 1]

With reference to (a) to (c) of FIG. 3, the description below deals with a specific example of how the character management information determining section 340 functions.

In a case where, for instance, a household electric appliance 5 is to start playing music, the household electric appliance 5 transmits the device ID “HE_3333” and the device operation information “play music” to the character management information determining section 340.

The character management information determining section 340, which has obtained the device ID and device operation information, refers to the character management DB 330 in of FIG. 3, and sets the character ID to “CH_0002” associated with the device ID “HE_3333 ”. The character management information determining section 340 also sets (i) the information ID to “20” (what the character 8 is currently doing) related to the device operation information “play music” and (ii) the character related information to “listen to music” related to the device operation information “play music ”.

It is assumed that the character storage DB 331 does not associate the character ID “CH_0002” with the information ID “20” or the character related information “listen to music ”. In this case, the character management information determining section 340 reflects such association in the character storage DB 331 and updates the character storage DB 331 as shown in the character storage DB 331 in (b) of FIG. 3.

As described above, the character management information determining section 340 is capable of referring to device management information and updating character management information even in a case where the character management information is not preset. The character management information determining section 340 is thus capable of further improving the relation between a household electric appliance 5 and a character 8.

In a case where the character storage DB 331 in (b) of FIG. 3 has a blank field under “App ID ”, the blank field indicates that the character management information in the character storage DB 331 is information related to the character 8 itself. In a case where the character storage DB 331 has information under “App ID ”, the information in the character storage DB 331 is information updated on the basis of, for example, conversation between the user and the character 8.

After updating the character storage DB 331, the character management information determining section 340 transmits the information ID “20” (what the character 8 is currently doing) and the character related information “listen to music” to the terminal device 2. The terminal control section 23 of the terminal device 2, when the household electric appliance 5 starts to play music, refers to the information ID and character related information, and changes the form of presenting the character 8 to “listen to music ”, for example. With this arrangement, the character management information determining section 340 is capable of, while the household electric appliance 5 is playing music, causing the character 8 having the character ID “CH_0002” to act as if the character 8 is also listening to music.

When the household electric appliance 5 ends playing music, the character management information determining section 340 transmits the information ID “20” (what the character 8 is currently doing) and the character related information “wait” to the terminal device 2. This allows the character management information determining section 340 to end the action of listening to music by the character 8 in conjunction with the operation of the household electric appliance 5. The word “wait” as used herein refers to a character having ended the previous action and waiting to take a subsequent action.

[Function of Character Management Information Determining Section 340: Specific Example 2]

The character management information determining section 340 may be configured to check the character storage DB 331 regularly (such as every second) to determine whether to change the form of presenting a character 8.

For instance, while the terminal device 2 is displaying a character 8 in which a character ID has been reflected, the terminal device 2 transmits the character ID to the character management information determining section 340 of the server 30 regularly.

The character management information determining section 340 refers to the character storage DB 331 and checks whether the information ID and character related information both associated with the character ID obtained have been updated. The character management information determining section 340 also checks whether the information ID and character related information both associated with the character ID obtained are related to device operation information.

It is assumed that an information ID and character-related stored both information associated with the character ID obtained have been newly added and that those information ID and character related information are related to device operation information. In this case, the character management information determining section 340 determines that the information ID and character related information newly added are new character management information. The character management information determining section 340 then transmits the character management information to the terminal device 2. The terminal control section 23 of the terminal device 2 refers to the character management information and changes the form of presenting the character 8.

As described above, the character management information determining section 340 is capable of checking the character storage DB 331 regularly. With the above arrangement, the character management information determining section 340 is capable of causing operation of a household electric appliance 5 to be reflected in more real time in the action of a character 8.

[Information Providing Process]

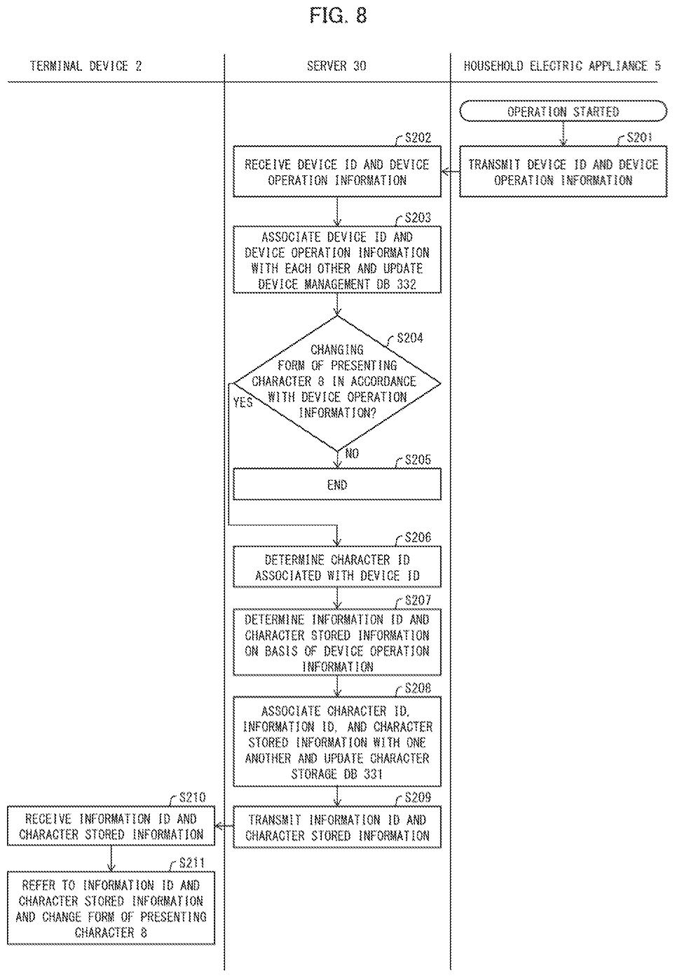

With reference to FIG. 8, the description below deals with an formation providing process information providing method) carried out by the display system 10 according to the present embodiment. FIG. 8 is a sequence diagram illustrating an example flow of the information providing process carried out by the display system 10 according to the present embodiment.

The display system 10 according to the present embodiment carries out an information providing process by carrying out the below-described steps S201 to S211.

Step S201: It is assumed that a household electric appliance 5 has started a new operation. In this case, the household electric appliance 5 transmits the device ID and device operation information of its own to the server 30 via the household electric appliance communication section 50.

Step S202: The device management information determining section 321 of the server 30 receives the device ID and device operation information from the household electric appliance 5 via the server communication section 31.

Step S203: The device management information determining section 321 of the server 30 refers to the device management DB 332 in (c) of FIG. 3 to associate the device ID and device operation information with each other. This allows the device management information determining section 321 of the server 30 to determine and update device management information. The device management DB 332 is updated as a result.

Step S204: In a case where the character management information determining section 340 of the server 30 is to change the form of presenting a character 8 in accordance with device operation information included in the updated device management information (YES in step S204), the process goes to step S206. In a case where the character management information determining section 340 of the server 30 is not to change the form of presenting a character 8 in accordance with device operation information included in the updated device management information (NO in step S204), the process goes to step S205.

Step S205: In the case where the character management information determining section 340 of the server 30 is not to change the form of presenting a character 8 in accordance with device operation information included in the updated device management information, the information providing process ends.

Step S206: The character management information determining section 340 of the server 30 refers to the character management DB 330 in (a) of FIG. 3 and determines the character ID associated with the device ID.

In a case where, for instance, the device ID is “HE_3333 ”, the character management information determining section 340 of the server 30 sets the character ID to “CH_0002 ”.

Step S207: The character management information determining section 340 of the server 30 determines an information ID and character related information on the basis of the device operation information.

In a case where, for instance, the device operation information indicates “play music ”, the character management information determining section 340 of the server 30 sets (i) the information. ID to “20” (what the character 8 is currently doing) related to the device operation information “play music” and the character related information to “listen to music” related to the device operation information “play music ”.

Step S208: The character management information determining section 340 of the server 30 associates the character ID with the information ID and character related information. This allows the character management information determining section 340 of the server 30 to determine and update character management information. The character storage DB 331 is updated as a result.

For instance, as shown in the character storage DB 331 in (b) of FIG. 3, the character management information determining section 340 determines “CH_0002 ”, the information ID “20” (what the character 8 is currently doing), and the character related information “listen to music” as character management information.

Step S209: The character management information determining section 340 of the server 30 transmits the determined information ID and character related information to the terminal device 2 via the server communication section 31 (character management information determining step).

As described above, the character management information determining section 340 of the server 30 is capable of referring to device management information and updating character management information even in a case where the character management information is not preset. The character management information determining section 340 of the server 3 thus allows the relation between a household electric appliance 5 and a character 8 to be improved further. The server 30 thus allows the relation between a household electric appliance 5 and a character 8 to be improved further.

Step S210: The terminal device 2 receives the information ID and character related information from the character management information determining section 340 of the server 30 via the terminal communication section 24.

Step S211: The terminal control section 23 of the terminal device 2 refers to the updated information ID and character related information and changes the form of presenting a character 8. With this arrangement, the terminal control section 23 of the terminal device 2 allows operation of a household electric appliance 5 to be reflected in real time in the action of a character 8.

The server 30 according to the present embodiment is arranged such that the server control section 34 is configured to, in accordance with device operation information, change the form of presenting a character 8, the device operation information being information related to operation of a household electric appliance 5 shown in a captured image 7.

The server control section 34 changes the form of presenting a character 8 in accordance with device operation information. The server control section 34 is thus capable of causing operation of a household electric appliance 5 and action of a character 8 to be in real-time conjunction with each other. The server 30 thus allows the relation between a household electric appliance 5 and a character 8 to be improved further.

The terminal device 2 according to the present embodiment is arranged such that the terminal control section 23 is configured to (i) refer to the form of presenting the character 8 which form has been changed in accordance with device operation information, which is information related to operation of the individual household electric appliance 5 shown in the captured image 7, and (ii) cause the display section 251 to superimpose the image of the character 8 over the captured image 7 captured by the image capturing section 21.

The terminal control section 23 is capable of referring to the form of presenting a character 8 which form has been changed in accordance with device operation information and causing the display section 251 to display an image of the character 8. With this arrangement, the terminal control section 23 allows a character 8 displayed on the display section 251 to act in real-time conjunction with the operation of a household electric appliance 5. With this arrangement, the terminal device 2 allows the relation between a household electric appliance 5 and a character 8 to be improved further.

### Embodiment 3

The server control section may have a function in addition to the function of the server control section 32 or 34 as a server control section 35 (not shown) of a display system 100 according to Embodiment 3.

[Display System 100]

The display system 100 (not shown) according to the present embodiment includes a server 300 (not shown) in place of the server 3 or 30. The server 300 includes a server control section 35 in place of the server control section 32 or 34. The server control section 35 includes a character management information determining section 350 in place of the character management information determining section 320 or 340. The server 300 is similar in configuration to the server 3 or 30 except for the above points.

[Server 300]

The server 300 includes a server control section 35 (not shown).

The server control section 35 includes a character management information determining section 350 (not shown), which refers to (i) terminal information such as an app ID and a password and (ii) character related information obtained from the history of conversation between a character 8 and the user. This allows the character management information determining section 350 to determine the content of speech by the character 8.

The character management information determining section 350 transmits, to the terminal device 2, data on the determined content of speech by the character 8. With this arrangement, the terminal control section 23 of the terminal device 2 is capable of causing the presenting section 25 such as the terminal voice output section 250 or the display section 251 to output the data on the content of speech. As a result, the terminal control section 23 of the terminal device 2 is capable of causing the user to recognize as if the character 8 has said something in response to what the user said.

As described above, the content of speech by a character 8 is not necessarily outputted by the terminal voice output section 250 (through a voice output), and may be outputted by the display section 251. For instance, the terminal control section 23 may cause the terminal voice output section 250 to say “You like fish, don't you?” through a voice output or cause the display section 251 to display “You like fish, don't you?” in text form.

[Function of Character Management Information Determining Section 350: Specific Example 1]

With reference to (a) and (b) of FIG. 3, the description below deals with a specific example of how the character management information determining section 350 functions.

For instance, it is assumed that the terminal control section 23 has caused a character 8 to ask the user the question “What food do you like?”. It is also assumed that the user has responded “I like fish” with use of the terminal information input section 22 such as the terminal voice input section 220 or the text input section 221. In this case, the character management information determining section 350, similarly to Embodiments 1 and 2, sets character related information associated with CH_0001 as a character ID and “1” as an information ID (favorite food of the user's) to indicate “fish ”. The character management information determining section 350 also updates the character storage DB 331 in (b) of FIG. 3.

It is assumed that the character management DB 330 has, in the App ID field in association with the character ID “CH_0001 ”, the app ID “AP_0011” of the terminal device 2 that the user is using. In this case, the character management information determining section 350 is capable of identifying the character 8 as a character 8 having unique character management information, which is allocated to each terminal device 2 of each user. In other words, the character management information determining section 350 is capable of selecting the character 8 as a pet character assigned individually to a terminal device 2.

In a case where the character management information determining section 350 has selected a character 8 as a pet character as described above, the character management information determining section 350 can cause the pet character to say, to the user, something different from that a typical character 8 says.

It is assumed, for instance, that the terminal device 2 that the user is using has the app ID “AP_0011” and that the character 8 having the character ID “CH_0001” is being displayed on the display section 251. In this case, the character management information determining section 350 refers to, in the character storage DB 331 in (b) of FIG. 3, that character management information in which the character ID is CH_0001. This allows the character management information determining section 350 to determine the content of speech by the character 8.

It is assumed that the character 8 is a pet character for the terminal device 2. In this case, the character management information determining section 350 is capable of referring also to character management information including private information and thereby determining the content of speech.

For instance, the character management information determining section 350 is capable of referring to the character storage DB 331 in (b) of FIG. 3 and thereby determining that the content of speech by the pet character is “You like fish, don't you?”. The character management information determining section 350 is also capable of determining that the content of speech by the pet character is “I am Joe Microwave! I live in the microwave oven in Mr. A's place!”.

It is assumed that the user has responded to the pet character that the user is from Chiba Prefecture. In this case, the character management information determining section 350 is capable of newly adding, to the character storage DB 331 as character management information including private information, information on the user being from Chiba Prefecture.

As described above, the character management information determining section 350 refers to an app ID and character related information and thereby determines the content of speech by a character 8. With this arrangement, the character management information determining section 350 is capable of causing a character 8 to say something different for each terminal device 2.

[Function of Character Management Information Determining Section 350: Specific Example 2]

(Function of Character Management Information Determining Section 350: Specific Example 2-1)

The example described above is an example of how the character management information determining section 350 functions in a case where the character 8 is a pet character for a terminal device 2. The function of the character management information determining section 350 is, however, also applicable to a case where the character 8 is a pet character for a person other than the user.

It is assumed, for instance, that the terminal device 2 of the user's has the app ID “AP_0600” and that the character 8 having the character ID “CH_0002” is being displayed on the display section 251. It is also assumed that the character management DB 330 does not have the app ID “AP_0600” under “App ID” in association with the character ID “CH_0002” as in the character management DB 330 in (a) of FIG. 3.

In this case, the character management information determining section 350, when referring to the character storage DB 331 in (b) of FIG. 3, avoids determining that character management information including private information is the content of speech. In other words, the character management information determining section 350 refers to that piece of character management information associated with the character ID “CH_0002” which does not include private information, and thereby determines the content of speech. For instance, the character management information determining section 350 is capable of setting the content of speech to “I am Joe Microwave! I am listening to music!” but is incapable of setting the content of speech to “You like meat, don't you?”.

Even with the above arrangement, the character management information determining section 350 refers to an app ID and character related information and thereby determines the content of speech by a character 8. With this arrangement, the character management information determining section 350 is capable of presenting a character 8 in a form different for each terminal device 2.

It is assumed that the user has responded to a character 8 other than the pet character that the user is from Chiba Prefecture. In a case where the user has provided a response to a character 8 other than the pet character which response includes private information as described above, the character management information determining section 350 does not need to add, to the character storage DE 331, information on the user being from Chiba Prefecture.

(Function of Character Management Information Determining Section 350: Specific Example 2-2)

The character management information determining section 350 may be capable of setting a character 8 to a pet character of the user's even in a case where that character 8 is a pet character for a person other than the user.

It is assumed, for instance, that the terminal device 2 of the user's has the app ID “AP_0600” and the character ID “CH_0002 ”. In this case, the character management information determining section 350 causes the character 8 to say, for example, “If you want me to be a pet character of yours, let me know your password!”. The character management information determining section 350 accepts a password from the user via the terminal information input section 22. The user may input a password into the terminal voice input section 220 in vocal form or into the text input section 221 in text form.

In a case where the terminal information input section 22 has accepted a voice input or text input from the user, the terminal information obtaining section 234 extracts a password from the input information. The terminal information obtaining section 234 transmits the password to the character management information determining section 350 of the server 300 via the terminal communication section 24.

The character management information determining section 350 checks whether the password is identical to the password “*Z˜?” associated with the character ID “CH_0002 ”. If the password is identical to “*Z˜?”, the character management information determining section 350 associates the character ID “CH_0002” and the password “AP_0600” with each other. This allows “AP_0600” to be added under “App ID” of the character management DR 330 in (a) of FIG. 3 in association with the character ID “CH_0002 ”. As a result, the character management information determining section 350 can set a character 8 serving as a pet character of a person other than the user to a pet character of the user who has the terminal device 2 of which the app ID is “AP_0600 ”.

[Function of Character Management Information Determining Section 350: Specific Example 3]

The example described above is an example of how the character management information determining section 350 functions in a case where the character 8 is a character 8 in which a character ID has been reflected. The function of the character management information determining section 350 is, however, also applicable to a case where a character 8 displayed on the display section 251 is a general character in which a character ID has not been reflected.

The term “general character” refers to, for example, a character 8 in which information such as a character ID has not been reflected. In a case where, for instance, the device classification information indicates “microwave oven ”, the appearance of a general character is that of a microwave oven (Joe Microwave) personified with a face and deformed as illustrated in FIG. 2. Joe Microwave as a general character says something (such as “I am Joe Microwave!”) that does not include unique information.

Even in this case, the character management information determining section 350 may be capable of setting the character 8 to a pet character of the user's.

In this case, the character management information determining section 350 causes the character 8 to say, for example, “If you want me to be a pet character of yours, let me know your password!”. The character management information determining section 350 thus accepts, from the terminal device 2 of the user's, the app ID as well as the device ID and capturing position information.

The character management information determining section 350 associates the obtained password and at least either the device ID or the capturing position information with a new character ID. The character management DB 330 is updated as a result. This allows the user to set a general character to a pet character of the user's.

[Information Providing Process]

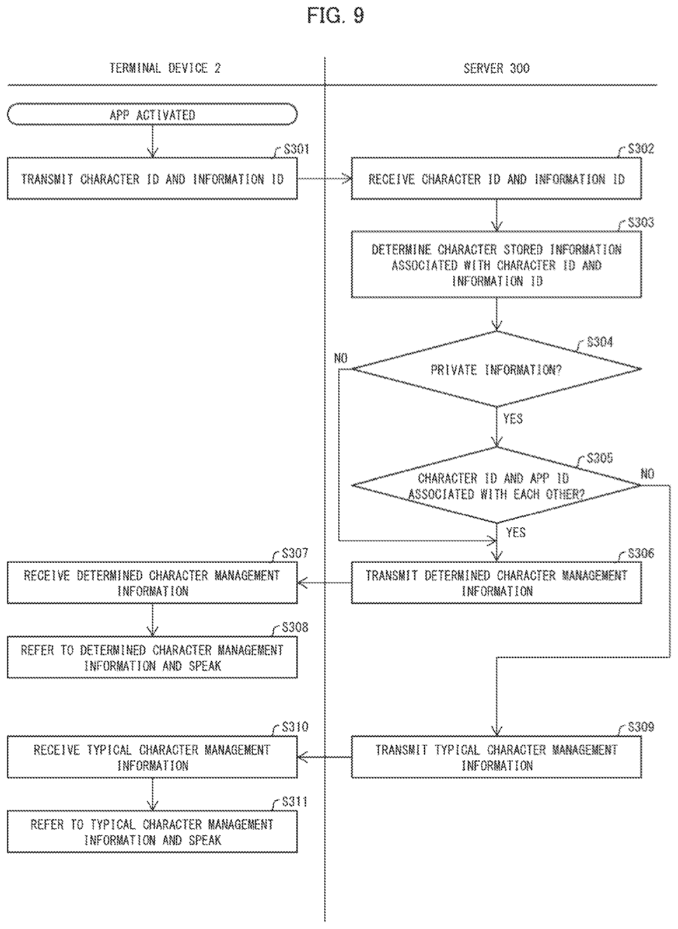

With reference to FIG. 9, the description below deals with an information providing process (information providing method) carried out by the display system 100 according to the present embodiment. FIG. 9 is a sequence diagram illustrating an example flow of the information providing process carried out by the display system 100 according to the present embodiment.

The display system 100 according to the present embodiment carries out an information providing process by carrying out the below-described steps S301 to S311.

Step S301: The description below deals with a case where (i) the display section 251 of the terminal device 2 is displaying a character 8 in which a character ID has been reflected and (ii) the terminal device 2 has activated an app that involves determining character management information.

First, the terminal control section 23 of the terminal device 2 transmits the character ID and an information ID to the server 300 via the terminal communication section 24.

Step S302: The character management information determining section 350 of the server 300 receives the character ID and information ID from the terminal device 2 via the server communication section 31.

Step S303: The character management information determining section 350 of the server 300 refers to the character storage DB 331 in (b) of FIG. 3. The character management information determining section 350 of the server 300 then determines character related information associated with the character ID and information ID.

Step S304: Next, the character management information determining section 350 of the server 300 refers to the character storage DB 331 in (b) of FIG. 3. In a case where the character management information determining section 350 of the server 300 has determined that the character related information is associated with private information (YES in step S304), the process goes to step S305. In a case where the character management information determining section 350 of the server 300 has determined that the character related information is not associated with private information (NO in step S304), the process goes to step S306.

Step S305: The character management information determining section 350 of the server 300 refers to the character storage DB 331 in (b) of FIG. 3. In a case where the character management information determining section 350 of the server 300 has determined that the character ID is associated with an app ID (YES in step S305), the process goes to step S306. In a case where the character management information determining section 350 of the server 300 has determined that the character ID is not associated with an app ID (NO in step S305), the process goes to step S309.

Step S306: The character management information determining section 350 sets the character 8 as a pet character of the user's, and associates the character ID, the app ID, the information ID, and the character related information with one another. This allows the character management information determining section 350 to determine character management information and also determine the content of speech by the pet character. The character management information determining section 350 transmits the determined character management information to the terminal device 2 via the server communication section 31.

For instance, it is assumed that the character ID is “CH_0001 ”, the app ID is “AP_0011 ”, the information ID is “1” (favorite food of the user's), and the character related information indicates “fish ”. In this case, the character management information determining section 350 is capable of setting the content of speech by the pet character to “You like fish, don't you?”. After setting the content of speech, the character management information determining section 350 transmits data on the content of speech to the terminal device 2, and instructs the terminal device 2 to output the content of speech.

Step S307: The terminal control section 23 of the terminal device 2 receives the character management information from the server 300 via the terminal communication section 24.

Step S308: The terminal control section 23 of the terminal device 2 refers to the character management information and thereby says something to the user.

Step S309: In a case where the character ID is not associated with an app ID, the character management information determining section 350 sets character management information to something typical. Specifically, the character management information determining section 350 sets the content of speech by the character 8 to something typical that does not include private information. After setting the content of speech, the character management information determining section 350 transmits data on the content of speech to the terminal device 2, and instructs the terminal device 2 to output the content of speech.

For instance, the character management information determining section 350 sets the content of speech by the character 8 to “I am Joe Microwave!”, and transmits data on the content of speech to the terminal device 2.

Step S310: The terminal control section 23 of the terminal device 2 receives the typical character management information from the server 300 via the terminal communication section 24.

Step S311: The terminal control section 23 of the terminal device 2 refers to the typical character management information and thereby says something to the user.

[Information Providing Process: Variation 1]

The character management information determining section 350 of the server 300 in the display system 100 is capable of carrying out an information providing process even in the case below.

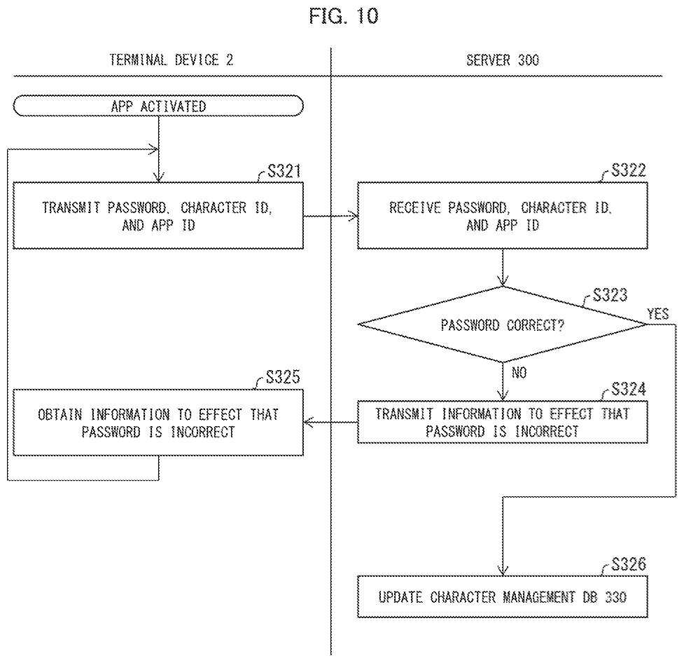

With reference to FIG. 10, the description below deals with Variation 1 of the information providing process carried out by the display system 100 according to the present embodiment. FIG. 10 is a sequence diagram illustrating an example flow of the information providing process carried out by the display system 100 according to the present embodiment.

The display system 100 according to the present embodiment can carry out an information providing process by carrying out the below-described steps S321 to S326 as well.

Step S321: The description below deals with a case where (i) the display section 251 of the terminal device 2 is displaying a pet character for a person other than the user in which pet character a character ID has been reflected and (ii) the terminal device 2 has activated an app that involves determining character management information.

In this case, the terminal control section 23 of the terminal device 2 obtains, via the terminal information input section 22, a password entered by the user. The terminal control section 23 of the terminal device 2 transmits the character ID and app ID to the server 300 together with the password obtained.

Step S322: The character management information determining section 350 of the server 300 receives the password, the character ID, and the app ID from the terminal device 2 via the server communication section 31.

Step 323: The character management information determining section 350 of the server 300 refers to the character management DB 330 shown in (a) of FIG. 3. The character management information determining section 350 of the server 300 checks whether the password obtained is identical to that associated with the character ID in the character management DB 330 in (a) of FIG. 3.

In a case where the character management information determining section 350 of the server 300 has determined that the password obtained is identical to the password in the character management DB 330 in (a) of FIG. 3 (YES in step S323), the process goes to step S326. In a case where the character management information determining section 350 of the server 300 has determined that the password obtained is not identical to the password in the character management DB 330 in (a) of FIG. 3 (NO in step S323), the process goes to step S324.

Step S324: The character management information determining section 350 of the server 300 transmits, to the terminal device 2 via the server communication section 31, a notification to the effect that the password is incorrect.

Step S325: The terminal device 2 receives, from the server 300 via the terminal communication section 24, the notification to the effect that the password is incorrect. The terminal device 2 accepts an input of a password from the user via the terminal information input section 22 again.

For instance, the terminal device 2 outputs, from the terminal voice output section 250 or display section 251 of the presenting section 25 in voice or text form, information to the effect that the password is incorrect.

Step S326: The character management information determining section 350 of the server 300 associates the character ID, the app ID, and the password with one another. Specifically, the character management information determining section 350 of the server 300 adds, as an app ID associated with the character ID, the app ID of the user of the terminal device 2 that has carried out the above information providing process. This allows the character management DB 330 to be updated, thereby setting a character 8 that used to be a pet character for a person other than the user to a pet character for the user of the terminal device 2 that has carried out the above information providing process.

[Information Providing Process: Variation 2]

The character management information determining section 350 of the server 300 in the display system 100 is capable of carrying out an information providing process even in the case below.

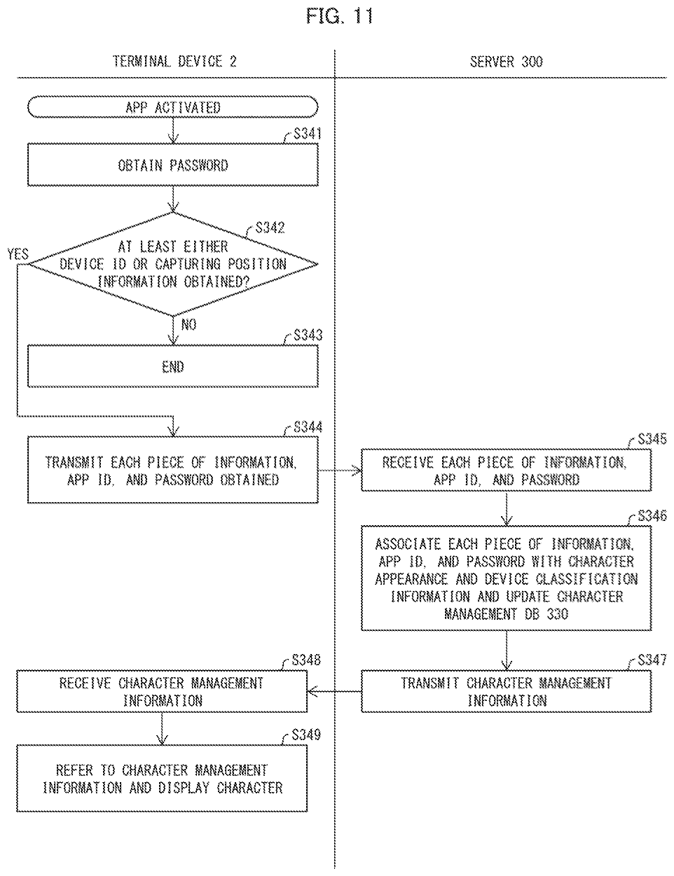

With reference to FIG. 11, the description below deals with Variation 2 of the information providing process carried out by the display system 100 according to the present embodiment. FIG. 11 is a sequence diagram illustrating an example flow of the information providing process carried out by the display system 100 according to the present embodiment.

The display system 100 according to the present embodiment can carry out an information providing process by carrying out the below-described steps S341 to S349 as well.

Step S341: The description below deals with a case where (i) the display section 251 of the terminal device 2 is displaying a general character in which a character ID has not been reflected and (ii) the terminal device 2 has activated an app that involves creating a new character 8.

In this case, the terminal control section 23 of the terminal device 2 obtains a password from the user via the terminal information input section 22. The password is set by the user as appropriate.

Step S342: Next, the terminal control section 23 of the terminal device 2 determines whether the terminal control section 23 of the terminal device 2 has obtained at least either the device ID of a household electric appliance 5 or capturing position information. In a case where the terminal control section 23 of the terminal device 2 has determined that the terminal control section 23 of the terminal device 2 has obtained at least either the device ID or capturing position information (YES in step S342), the process goes to step S344. In a case where the terminal control section 23 of the terminal device 2 has determined that the terminal control section 23 of the terminal device 2 has not obtained at least either the device ID or capturing position information (NO in step S342), the process goes to step S343.

Step S343: In a case where the terminal control section 23 of the terminal device 2 has determined that the terminal control section 23 of the terminal device 2 has not obtained at least either the device ID or capturing position information, the information providing process ends.

Step S344: The terminal control section 23 of the terminal device 2 transmits each obtained piece of at least either the device ID or capturing position information, the app ID, and a password to the server 300 via the terminal communication section 24.

Step S345: The character management information determining section 350 of the server 300 receives the obtained piece of information, the app ID, and the password from the terminal device 2 via the server communication section 31.

Step S346: The character management information determining section 350 of the server 300 associates the obtained piece of information, the app ID, the password, device classification information, and information on the appearance of the character with one another, and thereby determines character management information. The character management information determining section 350 of the server 300 reflects the character management information in the character management DB 330 for addition. This creates a new character 8, and changes the general character, displayed by the terminal device 2 that has carried out the above information providing process, into a pet character.

The character management information determining section 350 adds, to the character management DB 330 in (a) of FIG. 3, only that of the device ID and the capturing position information which the character management information determining section 350 has obtained.

Step S347: The character management information determining section 350 of the server 300 transmits the determined character management information to the terminal device 2 via the server communication section 31.

Step S348: The terminal control section 23 of the terminal device 2 receives the character management information via the terminal communication section 24.

Step S349: The terminal control section 23 of the terminal device 2 refers to the character management information and thereby causes the display section 251 to superimpose an image of the pet character over a captured image 7.

As described above, the server 300 according to the present embodiment is arranged such that the server control section 35 is configured to select the content of speech by the character 8 with reference to (i) an app ID for distinguishing between the terminal device 2 and another terminal device and (ii) character related information obtainable from the history of conversation between the character 8 and the user.

The server control section 35 of the server 300 selects the content of speech by a character 8 with reference to an app ID and character related information. With this arrangement, the character management information determining section 350 is capable of causing a character 8 to say something different for each terminal device 2.

The terminal device 2 according to the present embodiment is arranged such that the terminal control section 23 is configured to cause the presenting section 25 to output the content of speech by a character 8 which content has been selected with reference to (i) the app ID for distinguishing between the terminal device 2 and another terminal device and (ii) character related information obtainable from the history of conversation between the character 8 and the user.

The terminal control section 23 of the terminal device 2 is configured to cause the presenting section 25 to output the content of speech by a character 8 which content has been selected with reference to an app ID and character related information. The terminal control section 23 is thus capable of causing the presenting section 25 to say something different for each terminal device 2.

### Embodiment 4

The server control section may have a function in addition to the function of the server control section 32, 34, or 35 as a server control section 36 (not shown) of a server 3000 (not shown) according to Embodiment 4.

[Display System 500]

The display system 500 (not shown) according to the present embodiment includes a server 3000 (not shown) in place of the server 3, 30, or 300. The server 3000 includes a server control section 36 in place of the server control section 32, 34, or 35. The server control section 36 includes a character management information determining section 360 (not shown) in place of the character management information determining section 320, 340, or 350. The server 3000 is similar in configuration to the server 3, 30, or 300 except for the above points.

[Server 3000]

The server 3000 includes a server control section 36 (not shown).

The character management information determining section 360 (not shown) of the server control section 36 has a function in addition the function of the server control section 32, 34, or 35. The additional function is the function of determining character management information with further reference to association information in which a plurality of pieces of device identification information that are different from each other are associated with identical character determining information.

It is assumed that the character management information determining section 360 has newly obtained device identification information that differs from device identification information already stored in the character management DB 330. It is also assumed that the character management information determining section 360 has newly obtained an app ID that is identical to an app ID already stored in the character management DB 330.

In this case, the character management information determining section 360 associates (i) the newly obtained device identification information with (ii) the character management information associated with the app ID stored in the character management DB 330. In other words, the character management information determining section 360 associates the newly obtained device identification information with an existing character ID and the appearance of the character. The character management information determining section 360 then reflects the association in the character management DB 330 for addition.

Subsequently, the character management information determining section 360 determines, as character management information, the character ID and the appearance of the character both associated with the device identification information added. This allows a new character 8 to be created.

As described above, the character management information determining section 360 is capable of determining, even in a case where a plurality of household electric appliances 5 have respective pieces of device identification information different from each other, that those household electric appliances 5 share identical character management information. This allows the character management information determining section 360 to associate a plurality of household electric appliances 5 with identical character management information so that those household electric appliances 5 are grouped together. As a result, the character management information determining section 360 allows an identical character 8 to be shared by a plurality of household electric appliances 5.

For instance, in a case where a plurality of users have respective device IDs different from each other, the character management information determining section 360 allows the respective terminal devices 2 of the users to display respective characters 8 having an identical appearance and character ID. In other words, the character management information determining section 360 allows the characters 8 displayed by the respective terminal devices 2 of different users to share identical internal information. This in turn makes it possible to cause the characters 8 displayed by the respective terminal devices 2 of different users to say something identical such as “You like fish, don't you?”.

[Information Providing Process]

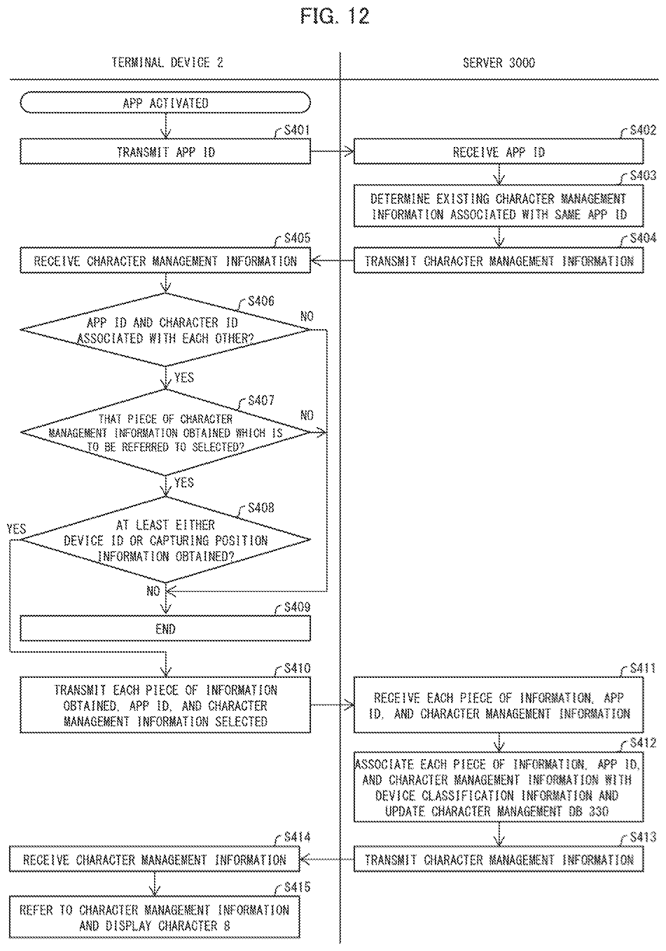

With reference to FIG. 12, the description below deals with an information providing process (information providing method) carried out by the display system 500 according to the present embodiment. FIG. 12 is a sequence diagram illustrating an example flow of the information providing process carried out by the display system 500 according to the present embodiment.

The display system 500 according to the present embodiment carries out an information providing process by carrying out the below-described steps S401 to S415.

Step S401: The description below deals with a case where (i) the display section 251 of the terminal device 2 is displaying a general character in which a character ID has not been reflected. This case also assumes that the terminal device 2 has activated an app that involves requesting sharing of a pet character associated with another household electric appliance 5.

First, the terminal device 2 transmits the app ID to the server 3000 via the terminal communication section 24.

Step S402: The server 3000 receives the app ID from the terminal device 2 via the server communication section 31.

Step S403: The character management information determining section 360 of the server 3000 refers to the character management DB 330 in (a) of FIG. 3 and thereby determines character management information associated with the same app ID as the newly obtained app ID.

Step S404: The character management information determining section 360 transmits the character management information to the terminal device 2 via the server communication section 31.

Step S405: The terminal control section 23 of the terminal device 2 receives the character management information from the server 3000 via the terminal communication section 24.

Step S406: The terminal control section 23 of the terminal device 2 refers to the character management information received. The terminal control section 23 then determines whether the terminal control section 23 has obtained not fewer than one set of character management information in which an app ID and a character ID are associated with each other. In a case where the terminal control section of the terminal device 2 has determined that the terminal control section 23 of the terminal device 2 has obtained not fewer than one piece of such character management information (YES in step S406), the process goes to step S407. In a case where the terminal control section 23 of the terminal device 2 has determined that the terminal control section 23 of the terminal device 2 has not obtained any piece of such character management information (NO in step S406), the process goes to step S409.

Step S407: In a case where the terminal control section 23 of the terminal device 2 is to select which piece to refer to from among different pieces of the character management information obtained (YES in step S407), the process goes to step S408. In a case where the terminal control section 23 of the terminal device 2 is not to select which piece to refer to from among different pieces of the character management information obtained (NO in step S407), the process goes to step S409.

Step S408: Next, the terminal control section 23 of the terminal device 2 determines whether the terminal control section 23 of the terminal device 2 has obtained at least either the device ID of a household electric appliance 5 or capturing position information. In a case where the terminal control section of the terminal device 2 has determined that the terminal control section 23 of the terminal device 2 has obtained at least either the device ID or capturing position information (YES in step S408), the process goes to step S410. In a case where the terminal control section 23 of the terminal device 2 has determined that the terminal control section 23 of the terminal device 2 has not obtained at least either the device ID or capturing position information (NO in step S408), the process goes to step S409.

Step S409: In a case where the terminal control section 23 of the terminal device 2 has determined that the terminal control section 23 of the terminal device 2 has not obtained at least either the device ID or capturing position information, the information providing process ends.

Step S410: The terminal control section 23 of the terminal device 2 transmits each obtained piece of at least either the device ID or capturing position information, the app ID, and a password to the server 3000 via the terminal communication section 24.

Step S411: The character management information determining section 360 of the server 3000 receives the obtained piece of information, the app ID, and the password via the server communication section 31.

Step S412: The character management information determining section 360 of the server 3000 associates the obtained piece of information, the app ID, and the character management information with one another. In other words, the character management information determining section 360 of the server 3000 associates the newly obtained device identification information with an existing character ID and the appearance of the character. The character management information determining section 360 then reflects the association in the character management DB 330 for addition.

Subsequently, the character management information determining section 360 of the server 3000 determines, as character management information, the character ID and the appearance of the character both associated with the device identification information added. This allows a new character 8 to be created.

The character management information determining section 360 of the server 3000 adds, to the character management DB 330 in (a) of FIG. 3, only that of the device ID and the capturing position information which the character management information determining section 360 has obtained. The character management information determining section 360, when creating a new character 8, avoids setting the device identification information of the character 8 to device identification information identical to that of another character 8. In other words, the character management information determining section 360 avoids setting the device identification information of a new character 8 to existing device identification information of another character 8 even in a case where those characters 8 share an identical app ID. The character management information determining section 360 directly reflects, in the character management DB 330, the device identification information newly obtained by the terminal device 2.

The above arrangement allows the character management information determining section 360 to create a character 8 of which (i) the device identification information differs from that of another character 8, but (ii) the character management information indicates an identical character ID and identical character appearance. The character management information determining section 360 is thus capable of determining identical character management information for different device identification information in a case where the app ID is identical.

Step S413: The character management information determining section 360 of the server 3000 transmits the character management information to the terminal device 2 via the server communication section 31.

Step S414: The terminal control section 23 of the terminal device 2 receives the character management information from the server 3000 via the terminal communication section 24.

Step S415: The terminal control section 23 of the terminal device 2 superimposes an image of the new character 8 over a captured image 7.

### Embodiment 5

The examples described above are each an example of a display system 1, 10, 100, or 500 including a terminal device 2 and a server 3, 30, 300, or 3000. The display system may, however, omit either a terminal device 2 or a server 3, 30, 300, or 3000.

In other words, all the members may be included in a terminal device 2 or a server 3, 30, 300, or 3000.

The description below deals with a display system 1000 that does not include a server 3, 30, 300, or 3000.

[Display System 1000]

The display system 1000 according to the present embodiment includes a terminal device 20.

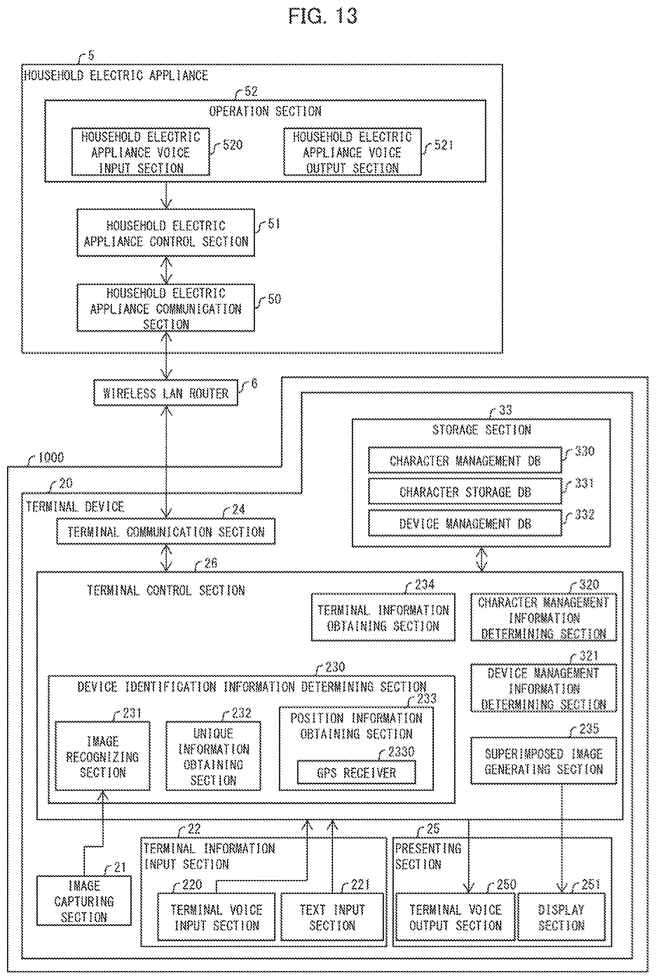

FIG. 13 is a block diagram of the configuration of a main part of the display system 1000 according to the present embodiment. As illustrated in FIG. 13, the terminal device 20 according to the present embodiment includes not only the above-described members of the terminal device 2, but also the storage section 33 that the server 3 for Embodiment 1 includes. The terminal device 20 includes a terminal control section 26 that includes not only the members that the terminal control section 23 includes, but also the character management information determining section 320 and the device management information determining section 321 that the server control section 32 of the server 3 for Embodiment 1 includes.

The display system 1000 according to Embodiment 5 produces an effect similar to that produced by the display system 1 according to Embodiment 1.

Any member of the present embodiment that is identical in function to a member described for any of the above embodiments is assigned an identical reference sign, and is riot described here again.

[Information Providing Process]

The display system 1000 according to the present embodiment carries out an information providing process (information providing method) that does not involve data transmission between the terminal communication section 24 and the server communication section 31. The information providing process is controlled by the terminal control section 26 of the terminal device 20 in place of the server control section 32 of the server 3. Except for these points, the information providing process is carried out similarly to the information providing process carried out by the display system 1 according to Embodiment 1.

### Embodiment 6

For Embodiment 5, the terminal control section 26 of the terminal device 20 refers to character management information to determine device management information. The terminal control section may have a function in place of or in addition to the function of the terminal control section 26 as a terminal control section 27 (not shown) of a terminal device 200 (not shown) for Embodiment 6. The additional function is the function of referring to device management information and determining character management information.

[Display System 1500]

The display system 1500 (not shown) according to the present embodiment includes a terminal device 200 (not shown).

The terminal device 200 according to the present embodiment includes a terminal control section 27 that includes not only the above-described members that the terminal control section 23 of the terminal device 2 includes, but also the character management information determining section 340 that the server control section 34 of the server 30 for Embodiment 2 includes.

The display system 1500 according to Embodiment 6 produces an effect similar to that produced by the display system 10 according to Embodiment 2.

[Information Providing Process]

The display system 1500 according to the present embodiment carries out an information providing process (information providing method) that does not involve data transmission between the terminal communication section 24 and the server communication section 31. The information providing process is controlled by the terminal control section 27 of the terminal device 200 in place of the server control section 34 of the server 30. Except for these points, the information providing process is carried out similarly to the information providing process carried out by the display system 10 according to Embodiment 2.

### Embodiment 7

The terminal control section may have a function in addition to the function of the terminal control section 26 or 27 as a terminal control section 28 (not shown) of a display system 2000 according to Embodiment 7.

[Display System 2000]

The display system 2000 according to the present embodiment includes a terminal device 400 (not shown).

The terminal device 400 according to the present embodiment includes a terminal control section 28 that includes not only the above-described members that the terminal control section 23 of the terminal device 2, but also the character management information determining section 350 that the server control section 35 of the server 300 according to Embodiment 3 includes.

The display system 2000 according to Embodiment 7 produces an effect similar to that produced by the display system 100 according to Embodiment 3.

[Information Providing Process]

The display system 2000 according to the present embodiment carries out an information providing process (information providing method) that does not involve data transmission between the terminal communication section 24 and the server communication section 31. The information providing process is controlled by the terminal control section 28 of the terminal device 400 in place of the server control section 35 of the server 300. Except for these points, the information providing process is carried out similarly to the information providing process carried out by the display system 100 according to Embodiment 3.

### Embodiment 8

The terminal control section may have a function in addition to the function of the terminal control section 26, 27, or 28 as a terminal control section 29 (not shown) of a display system 2500 (not shown) according to Embodiment 8.

[Display System 2500]

The display system 2500 according to the present embodiment includes a terminal device 600 (not shown).

The terminal device 600 according to the present embodiment includes a terminal control section 29 that includes not only the above-described members that the terminal control section 23 of the terminal device 2, but also the character management information determining section 360 that the server control section 36 of the server 3000 according to Embodiment 4 includes.

The display system 2500 according to Embodiment 8 produces an effect similar to that produced by the display system 500 according to Embodiment 4.

[Information Providing Process]

The display system 2500 according to the present embodiment carries out an information providing process (information providing method) that does not involve data transmission between the terminal communication section 24 and the server communication section 31. The information providing process is controlled by the terminal control section 29 of the terminal device 600 in place of the server control section 36 of the server 3000. Except for these points, the information providing process is carried out similarly to the information providing process carried out by the display system 500 according to Embodiment 4.

### Embodiment 9

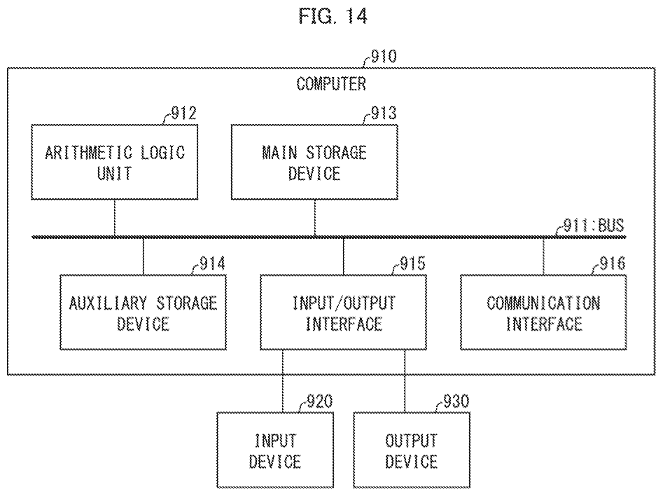

Each block of the terminal device 2, 20, 200, 400, 600 and the server 3, 30, 300, 3000 can be realized by a logic circuit (hardware) provided in an integrated circuit (IC chip) or the like or can be alternatively realized by software as executed by one or more processors. In the latter case, each of the terminal device 2, 20, 200, 400, 600 and the server 3, 30, 300, 3000 can be realized with use of a computer (electronic calculator) as illustrated in FIG. 14.

FIG. 14 is a block diagram of the configuration of a computer 910 by which the terminal device 2, 20, 200, 400, 600 or the server 3, 30, 300, 3000 can be realized. The computer 910 includes (i) an arithmetic logic unit 912, (ii) a main storage device 913, (iii) an auxiliary storage device 914, (iv) input/output interface 915, and (v) a communication interface 916 that are connected to each other via a bus 911. Each of the arithmetic logic unit 912, the main storage device 913, and the auxiliary storage device 914 can be realized by, for example, one or more processors, a random access memory (RAM), or a storage such as a hard disk drive and a flash memory. The input/output interface 915 is connected with (i) an input device 920 via which a user inputs various information into the computer 910 and (ii) an output device 930 via which the computer 910 outputs various information to the user. Each of the input device 920 and the output device 930 can be embedded in the computer 910 or can be alternatively connected to the computer 910 (externally connected to the computer 910). For example, the input device 920 can be a keyboard, a mouse, a touch sensor, or the like, and the output device 930 can be a display, a printer, a speaker, or the like. Alternatively, a device having both of a function of the input device 920 and a function of the output device 930 (such as a touch panel into which a touch sensor and a display are integrated) can be employed. The communication interface 916 is an interface via which the computer 910 communicates with an external device.

The auxiliary storage device 914 stores various programs for causing the computer 910 to operate as the terminal device 2, 20, 200, 400, 600 or the server 3, 30, 300, 3000. The arithmetic logic unit 912 causes the computer 910 to operate as sections included in the terminal device 2, 20, 200, 400, 600 or the server 3, 30, 300, 3000 by (i) loading, onto the main storage device 913, the programs stored in the auxiliary storage device 914 and executing instructions carried out in the programs. Note that a recording medium which is included in the auxiliary storage device 914 for recording information, such as the various programs, only needs to be a computer-readable “non-transitory tangible medium.” Examples of the recording medium include tapes, disks, cards, semiconductor memories, and programmable logic circuits.

The various programs can be obtained from outside of the computer 910. In such a case, the various programs can be obtained via any transmission medium (such as a communication network or a broadcast wave). The present invention can also be achieved in the form of a computer data signal in which the various programs are embodied via electronic transmission and which is embedded in a carrier wave.

As described above, the program for causing the computer 910 according to the present embodiment to function as the server control section 32, 34, 35, or 36 is a program for causing the computer 910 to function as the server 3, 30, 300, or 3000.

The program for causing the computer 910 to function is capable of causing the computer 910 to function suitably as the server control section 32, 34, 35, or 36 of the server 3, 30, 300, or 3000.

The program for causing the computer 910 according to the present embodiment to function as the terminal control section 23, 26, 27, 28, or 29 is a program for causing the terminal device 20, 200, 400, or 600 to function.

The program for causing the computer 910 to function is capable of causing the computer 910 to function suitably as the terminal control section 23, 26, 27, 28, or 29 of the terminal device 2, 20, 200, 400, or 600.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 10, 100, 500, 1000, 1500, 2000, 2500 Display system

2, 20, 200, 400, 600 Terminal device

3, 30, 300, 3000 Server (information providing device)

4 Network

5 Household electric appliance (device)

6 Wireless LAN router

7 Captured image

8 Character

21 Image capturing section

22 Terminal information input section

23, 26, 28, 29 Terminal control section (control section)

24 Terminal communication section communication section)

25 Presenting section

31 Server communication section (communication section)

32, 34, 35, 36 Server control section (control section)

33 Storage section

50 Household electric appliance communication section

51 Household electric appliance control section

52 Operation section

220 Terminal voice input section

221 Text input section

230 Device identification information determining section

231 Image recognizing section

232 Unique information obtaining section

233 Position information obtaining section

234 Terminal information obtaining section

235 Superimposed image generating section

250 Terminal voice output section

251 Display section

320, 340, 350, 360 Character management information determining section

321 Device management information determining section

330 Character management DB

331 Character storage DB

332 Device management DB

520 Household electric appliance voice input section

521 Household electric appliance voice output section

1. An information providing device for providing information to a terminal device configured to superimpose an image of a character over a captured image,
the information providing device comprising:
a communication section; and
a control section,
the control section being configured to carry out control of at least either
(i) referring to device identification information for identifying an individual device shown in the captured image and (ii) determining character management information for managing a form of presenting the character, and
transmitting the determined character management information to the terminal device via the communication section,
or
referring to the character management information and determining device management information for determining a state that the individual device presents, and
transmitting the device management information to the individual device via the communication section.

2. The information providing device according to claim 1, wherein
the control section is configured to carry out control of at least either
referring to the device identification information and updating the character management information, or
referring to the character management information and updating the device management information.

3. The information providing device according to claim 1, wherein
the control section is configured to
select content of speech by the character with reference to (i) terminal identification information for distinguishing between the terminal device and another terminal device and (ii) character related information obtainable from a history of conversation between the character and a user.

4. The information providing device according to claim 1, wherein
the control section is configured to, in accordance with device operation information, change the form of presenting the character, the device operation information being information related to operation of the individual device shown in the captured image.

5. The information providing device according to claim 1, wherein
the device identification information includes device classification information, which is classification information obtainable from appearance of the individual device shown in the captured image.

6. The information providing device according to claim 5, wherein
the device identification information further includes capturing position information of the captured image.

7. The information providing device according to claim 5, wherein
the device identification information further includes unique information obtainable through communication with the individual device shown in the captured image.

8. A terminal device, comprising:
an image capturing section;
a presenting section;
a control section; and
a communication section,
the presenting section including a display section,
the control section being configured to carry out control of at least either
(i) obtaining, from an information providing device for providing information to the terminal device, character management information for managing a form of presenting a character which character management information has been determined with reference to device identification information for identifying an individual device shown in a captured image and (ii) causing the display section to superimpose an image of the character over the captured image captured by the image capturing section, or
transmitting the device identification information for identifying the individual device to the information providing device via the communication section.

9. The terminal device according to claim 8, wherein
the device identification information is associated with the character management information, which is referred to for determining device management information for determining a state that the individual device presents.

10. The terminal device according to claim 9, wherein
the control section is configured to cause the presenting section to output content of speech by the character which content has been selected with reference to (i) terminal identification information for distinguishing between the terminal device and another terminal device and (ii) character related information obtainable from a history of conversation between the character and a user.

11. The terminal device according to claim 9, wherein
control section is configured to (i) refer to the form of presenting the character which form has been changed in accordance with device operation information, which is information related to operation of the individual device shown in the captured image, and (ii) cause the display section to superimpose the image of the character over the captured image captured by the image capturing section.

12. A display system, comprising:
an information providing device; and
a terminal device,
terminal device including: an image capturing section; a presenting section;
a terminal control section; and a terminal communication section,
the presenting section including a display section,
the information providing device including: a server communication section; and a server control section,
the server control section being configured to carry out control of at least either
(i) referring to device identification information for identifying an individual device shown in a captured image and (ii) determining character management information for managing a form of presenting a character, and
transmitting the determined character management information to the terminal device via the server communication section,
or
referring to the character management information and determining device management information for determining a state that the individual device presents, and
transmitting the determined device management information to the individual device via the server communication section,
the terminal control section being configured to
refer to the character management information and cause the display section to superimpose an image of the character over the captured image captured by the image capturing section.

13. A computer readable non-transitory storage medium that stores a program for causing a computer to function as an information providing device according to claim 1, the program causing the computer to function as the control section.

14. A computer readable non-transitory storage medium that stores a program for causing a computer to function as a terminal device according to claim 9, the program causing the computer to function as the control section.

15. An information providing method for providing information to a terminal device configured to superimpose an image of a character over a captured image,
the information providing method comprising at least either:
(i) referring to device identification information for identifying an individual device shown in the captured image and (ii) determining character management information for managing a form of presenting the character, and
transmitting the determined character management information to the terminal device,
or
referring to the character management information and determining device management information for determining a state that the individual device presents, and
transmitting the determined device management information to the individual device.
